(19) United States
(12) Patent Application Publication
(10) Pub. No.: US 2026/0070322 A1
(43) Pub. Date: Mar. 12, 2026

(54) LAMINATING APPARATUS INCLUDING LAMINATING PORTION THAT LAMINATES FIRST MEMBER ON WHICH IMAGE IS RECORDED AND SECOND MEMBER TOGETHER

(71) Applicant: BROTHER KOGYO KABUSHIKI KAISHA, Nagoya (JP)

(72) Inventors: Yuwen WANG, Nagoya (JP); Ryosuke SAKAI, Nagoya (JP); Kazuaki OOKA, Nagoya (JP)

(21) Appl. No.: 19/389,790

(22) Filed: Nov. 14, 2025

Related U.S. Application Data
(63) Continuation of application No. PCT/JP2024/016440, filed on Apr. 26, 2024.

(30) Foreign Application Priority Data
May 15, 2023 (JP) 2023-080209

(51) Int. Cl. B32B 41/00; B32B 38/00; B32B 38/18

(52) U.S. Cl. CPC B32B 41/00; B32B 38/0004; B32B 38/145; B32B 38/1825; B32B 2309/06; B32B 2309/16

(57) ABSTRACT

In a laminating apparatus, a first roll is mountable on a first holder. A first conveying roller is configured to hold a first drawn-out portion of a first member that has been drawn out from the first roll. A controller is configured to perform: applying, using a first rotary drive portion, a first force to the first holder; and applying, using a second rotary drive portion, a second force to the first conveying roller. When driving, in a state where the first conveying roller holds the first drawn-out portion, the second rotary drive portion to apply the second force to rotate the first conveying roller for conveying the first drawn-out portion in a draw-out direction, the controller drives the first rotary drive portion to apply the first force to act on the first holder for urging the first drawn-out portion to be conveyed in a take-up direction.

### REFERENCE TO RELATED APPLICATIONS

This is a by-pass continuation application of International Application No. PCT/JP2024/016440 filed on Apr. 26, 2024 claiming priority from Japanese Patent Application No. 2023-080209 filed on May 15, 2023. The entire contents of the International Application and the priority application are incorporated herein by reference.

### BACKGROUND ART

A laminating apparatus known in the art records an image on a first member drawn out from a first roll and laminates the first member on which the image has been recorded and a second member drawn from a second roll together.

With the known apparatus described above, a printing unit forms a printed image on a recording medium drawn out from a recording media roll. The recording medium on which the printed image is formed is cut to a prescribed length by a first cutting unit, conveyed to a laminating unit, and superimposed on a laminate member drawn out from a laminate member roll by a guide roll in the laminating unit. The superimposed recording medium and laminate member are heated by pressure and heating rolls and then cut off by a second cutting unit. The recording media roll, the recording medium, the laminate member roll, and the laminate member correspond to the first roll, the first member, the second roll, and the second member, respectively.

### SUMMARY

In the known laminating apparatus, slack is generated in the first member when the first member is drawn out from the first roll farther than necessary. When slack is generated in the first member, problems may occur while recording images on the first member or laminating the first member and the second member together, resulting in abnormalities in the finished laminated product.

In view of the foregoing, it is an object of the present disclosure to provide a laminating apparatus capable of reducing the generation of slack in the first member.

In order to attain the above and other objects, according to one aspect, the present disclosure provides a laminating apparatus. The laminating apparatus includes: a first holder; a second holder; an image recording portion; a laminating portion; a first conveying roller; a first rotary drive portion; a second rotary drive portion; and a controller. A first roll is mountable on a first holder. The first roll is a first member that is wound into a roll. A second roll is mountable on the second holder. The second roll is a second member that is wound into a roll. The first conveying roller is disposed at a position between the first holder and the laminating portion. The first conveying roller is configured to hold a first drawn-out portion of the first member. The first drawn-out portion is a portion of the first member that has been drawn out from the first roll. The controller is configured to perform: recording, using the image recording portion, an image on the first drawn-out portion; laminating, using the laminating portion, the first drawn-out portion on which the image is recorded and a second drawn-out portion of the second member together, the second drawn-out portion being a portion of the second member that has been drawn out from the second roll; applying, using the first rotary drive portion, a first force to the first holder, the first force urging the first holder to rotate together with the first roll mounted on the first holder; and applying, using the second rotary drive portion, a second force to the first conveying roller, the second force rotating the first conveying roller. When driving, in a state where the first conveying roller holds the first drawn-out portion, the second rotary drive portion to apply the second force to rotate the first conveying roller for conveying the first drawn-out portion in a draw-out direction, the controller drives the first rotary drive portion to apply the first force to act on the first holder for urging the first drawn-out portion to be conveyed in a take-up direction opposite the draw-out direction.

According to the laminating apparatus with the configuration described above, the first force acting in the take-up direction for taking up the first member onto the first roll is applied to the first roll via the first holder when the first member is conveyed in the draw-out direction for drawing out the first member from the first roll, thereby reducing the generation of slack in the first member. As a result, the finished laminated product can be beautifully generated by recording an image on the slack-free first member and laminating the slack-free first member and second member together.

The laminating apparatus according to the present disclosure reduces generation of slack in the first member when recording an image on the first member and laminating the first member on which the image is recorded and the second member together.

### BRIEF DESCRIPTION OF DRAWINGS

FIG. 1A is a perspective view of a laminating apparatus.

FIG. 1B is a schematic cross-sectional view of a finished laminated product generated by the laminating apparatus.

FIG. 2 is a vertical cross-sectional view of the laminating apparatus.

FIG. 3 is a block diagram illustrating the electric configuration of the laminating apparatus.

FIG. 4 illustrates a part of a rotary drive unit of the laminating apparatus.

FIG. 5 is a flowchart illustrating steps in a laminating process executed by a control unit of the laminating apparatus.

FIG. 6A illustrates main components of the laminating apparatus prior to performing the laminating process.

FIG. 6B illustrates the main components of the laminating apparatus performing a skew correction control.

FIG. 6C illustrates the main components of the laminating apparatus performing the skew correction control.

FIG. 6D illustrates the main components of the laminating apparatus after second conveying rollers have nipped a first member.

FIG. 7A illustrates the main components of the laminating apparatus performing a slack elimination control.

FIG. 7B illustrates the main components of the laminating apparatus conveying the first member.

FIG. 7C illustrates the main components of the laminating apparatus performing an image recording operation.

FIG. 7D illustrates the main components of the laminating apparatus conveying the first member after laminating rollers have been driven.

FIG. 8A illustrates the main components of the laminating apparatus after conveying the first member to a position beneath a first cutting unit.

FIG. 8B illustrates the laminating apparatus after the first cutting unit has performed cutting.

FIG. 8C illustrates the laminating apparatus after a second cutting unit has performed cutting.

FIG. 8D illustrates the laminating apparatus performing a rewinding control.

FIG. 9A illustrates the first member being drawn out during the skew correction control.

FIG. 9B illustrates the first member being taken up during the skew correction control.

FIG. 10 is a flowchart illustrating steps in a maintenance process performed by the control unit of the laminating apparatus.

FIG. 11 is a block diagram illustrating the electric configuration of a laminating apparatus.

### DESCRIPTION

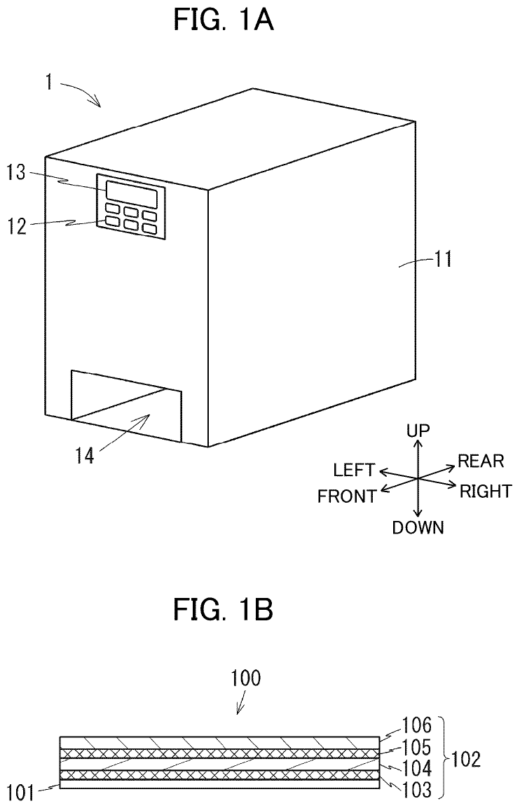

Below, a laminating apparatus 1 according to an embodiment of the present disclosure will be described. Note that the following embodiment is merely one example and that the present embodiment may be modified as appropriate without departing from the scope of the present disclosure. In the following description, the advancement from a start point to an end point of an arrow is expressed as a bearing (e.g., “toward”), while advancement in either of the opposing directions along a line connecting the start point and the end point of an arrow is expressed as a direction (e.g., “the left-right direction”). An up-down direction is defined based on the orientation of the laminating apparatus 1 when the laminating apparatus 1 is disposed in its operable state (the state illustrated in FIG. 1A). A front-rear direction is defined with the surface on which an operation unit 12 and a display unit 13 are disposed being designated as the front surface. A left-right direction is defined from the perspective of an observer facing the front side of the laminating apparatus 1. The up-down direction, the front-rear direction, and the left-right direction are orthogonal to each other.

### <Overview of the Laminating Apparatus 1>

As illustrated in FIG. 1A, the laminating apparatus 1 according to the present embodiment has a housing 11 with a rectangular parallelepiped shape. An operation unit 12 and a display unit 13 are disposed on the front surface of the housing 11. The front surface of the housing 11 has a discharge opening 14 below the operation unit 12 and the display unit 13. The laminating apparatus 1 laminates two types of members together to generate a finished laminated product 100.

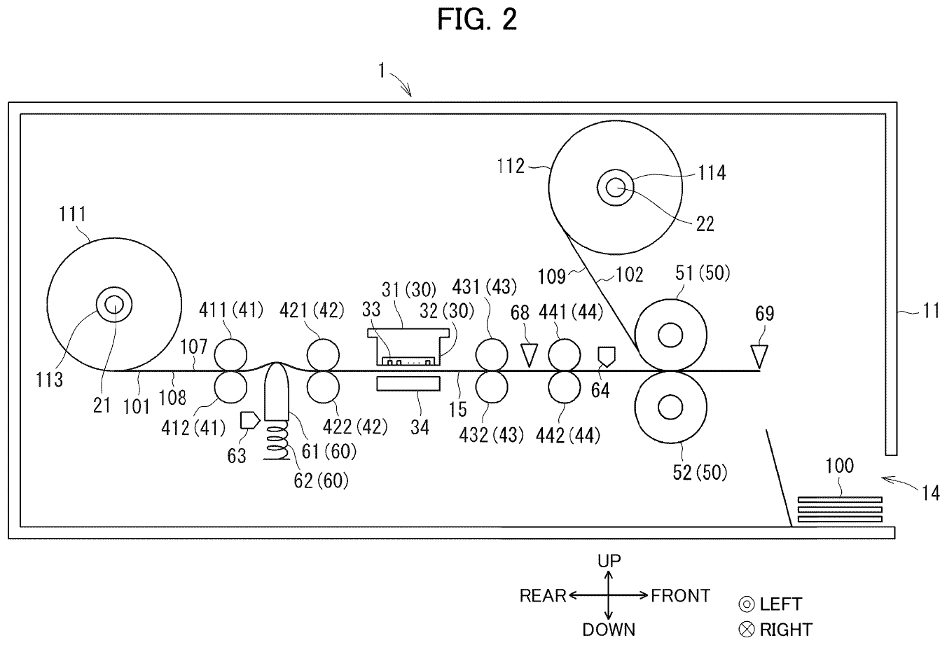

A tape-shaped first member 101 and a tape-shaped second member 102 are provided in the laminating apparatus 1. As illustrated in FIG. 2, the first member 101 is wound about a cylindrical core 113 to form a first roll 111, and the second member 102 is wound about a cylindrical core 114 to form a second roll 112. The first roll 111 and the second roll 112 are respectively mounted on a first holder 21 and a second holder 22 in the laminating apparatus 1.

The first member 101 is a transparent film, for example. The second member 102 has an adhesive layer on at least one surface. As illustrated in FIG. 1B, the second member 102 is a backing paper having a tape layer 104, a first adhesive layer 103 on one surface of the tape layer 104 (the surface on the side of the first member 101 in the finished laminated product 100), and a second adhesive layer 105 on the other surface of the tape layer 104, for example. A release sheet 106 is disposed on the opposite side of the second adhesive layer 105 from the tape layer 104.

The materials of the first member 101 and the second member 102 are not limited. For example, the second member 102 may be a resinous member such as PET (polyethylene terephthalate) or PVC (polyvinyl chloride), a synthetic paper such as YUPO (registered trademark) paper, or a metal member. The second member 102 may be transparent or opaque. Each of the first member 101 and the second member 102 may have an adhesive layer on one surface, on the other surface, on both surfaces, or on neither surface. When a material with no adhesive layer is used, the first member 101 and the second member 102 may be laminated together after an adhesive has been applied or may be laminated together through heat fusion or pressure joining, for example. “YUPO” is a registered trademark of YUPO CORPORATION.

As illustrated in FIG. 2, the first member 101 has a recording surface 107 on which images are recorded, and a back surface 108 on the side opposite the recording surface 107. The second member 102 has a lamination surface 109 on which the first adhesive layer 103 is formed.

The laminating apparatus 1 laminates the first member 101 and the second member 102 together by bringing the recording surface 107 of the first member 101 into close contact with the lamination surface 109 of the second member 102. The laminating apparatus 1 then cuts the laminated members into a predetermined size, thereby generating a finished laminated product 100 illustrated in FIG. 1B. The finished laminated product 100 generated through this process is discharged through the discharge opening 14.

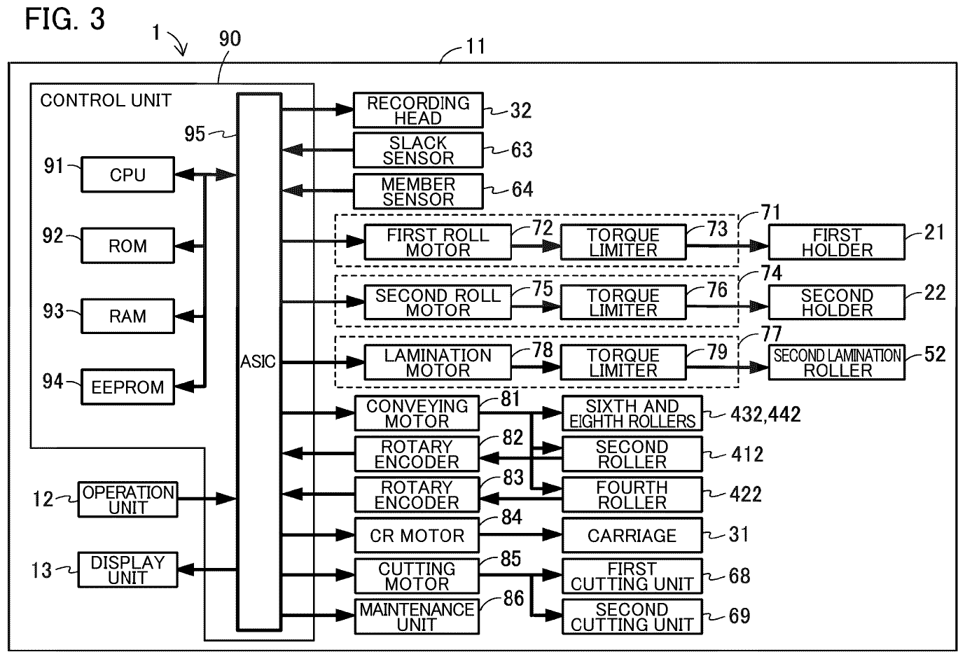

As illustrated in FIG. 2, the laminating apparatus 1 includes, inside the housing 11, a first holder 21, a second holder 22, an image recording unit 30, first through fourth conveying rollers 41-44, laminating rollers 50, a tension generating unit 60, a slack sensor 63, a member sensor 64, a first cutting unit 68, and a second cutting unit 69. The laminating apparatus 1 additionally includes, inside the housing 11, a control unit 90 and various motors (see FIG. 3). The laminating apparatus 1 further includes guide members (not illustrated) that support the first member 101. The guide members are arranged at appropriate positions within the housing 11. This arrangement forms a conveying path 15 that leads from the first holder 21 to the second cutting unit 69 via the image recording unit 30, the first cutting unit 68, and the laminating rollers 50. In the following description, a direction in which the first member 101 is conveyed along the conveyance path 15 from the first holder 21 toward the second cutting unit 69 is expressed as a conveying direction. The conveying direction is identical to the direction for drawing out the first member 101 from the first roll 111, which will be described later.

### <First Holder 21 and Second Holder 22>

Each of the first holder 21 and the second holder 22 is a rotatable member that can rotate about an axis extending in the left-right direction. The first holder 21 has a thickness equivalent to the inner diameter in the core 113 of the first roll 111. The second holder 22 has a thickness equivalent to the inner diameter in the core 114 of the second roll 112. Each of the first holder 21 and the second holder 22 is fixed either to the housing 11 or to a member fixed to the housing 11.

The first holder 21 and the second holder 22 are arranged in the housing 11 at positions spaced apart from each other. In the configuration illustrated in FIG. 2, the first holder 21 is disposed near the center of the housing 11 in the up-down direction and in the rear portion of the housing 11 in the front-rear direction. The second holder 22 is disposed in the upper portion of the housing 11 in the up-down direction and frontward relative to the center of the housing 11 in the front-rear direction. However, the positions of the first holder 21 and the second holder 22 within the housing 11 are not limited to these examples and may be set as desired.

Before the laminating apparatus 1 operates, the first roll 111 is mounted on the first holder 21, and the second roll 112 is mounted on the second holder 22. The first holder 21 supports the first roll 111 so that the first roll 111 is rotatable. The second holder 22 supports the second roll 112 so that the second roll 112 is rotatable. The first member 101 is drawn out from the first roll 111 supported by the first holder 21. The second member 102 is drawn out from the second roll 112 supported by the second holder 22. The first holder 21 is an example of the first holder of the present disclosure. The second holder 22 is an example of the second holder of the present disclosure.

A first roll motor 72 (see FIG. 3) applies a force to the first holder 21 acting in a direction for taking up the first member 101. A second roll motor 75 (see FIG. 3) applies a force to the second holder 22 acting in a direction for taking up the second member 102. The direction for taking up the first member 101 is an example of the take-up direction of the present disclosure.

### <Image Recording Unit 30>

The image recording unit 30 is disposed downstream relative to the first roll 111 along the conveying path 15 in the conveying direction. The image recording unit 30 is disposed upward relative to the conveying path 15 in the up-down direction and is positioned between the first roll 111 mounted on the first holder 21 and the first cutting unit 68 in the front-rear direction. The image recording unit 30 includes a carriage 31 and a recording head 32. Two guide rails (not illustrated) are disposed inside the housing 11. The guide rails extend in the left-right direction and both ends of the guide rails are fixed to the housing 11 or to members fixed to the housing 11. The carriage 31 is supported on the guide rails. The carriage 31 moves in the left-right direction when receiving a drive force from a CR motor 84 (see FIG. 3).

The recording head 32 is mounted on the carriage 31. A plurality of nozzles 33 are formed in the lower surface of the recording head 32. The recording head 32 moves in the left-right direction along with the movement of the carriage 31. A platen 34 is disposed downward relative to the carriage 31 in the up-down direction and covers a part of the moving range of the carriage 31 in the left-right direction. While moving in the left-right direction, the recording head 32 ejects ink downward from the nozzles 33, thereby recording an image on the recording surface 107 of the first member 101 as the first member 101 is conveyed over the platen 34. In this way, the image recording unit 30 records images on the first member 101 drawn out from the first member 101. The recording head 32 is an example of the head of the present disclosure.

### <First Through Fourth Conveying Rollers 41-44>

The first through fourth conveying rollers 41-44 are positioned between the first roll 111 mounted on the first holder 21 and the laminating rollers 50. Specifically, the first conveying rollers 41 and the second conveying rollers 42 are positioned between the first roll 111 mounted on the first holder 21 and the image recording unit 30 in the front-rear direction, while the third conveying rollers 43 and the fourth conveying rollers 44 are positioned between the image recording unit 30 and the laminating rollers 50 in the front-rear direction. The second conveying rollers 42 are disposed frontward relative to the first conveying rollers 41 in the front-rear direction. The fourth conveying rollers 44 are disposed frontward relative to the third conveying rollers 43 in the front-rear direction.

The first conveying rollers 41 include a first roller 411 and a second roller 412. The first roller 411 is disposed directly above the second roller 412. The first member 101 passes between the first roller 411 and the second roller 412. At this time, the first roller 411 contacts the recording surface 107 of the first member 101 and the second roller 412 contacts the back surface 108 of the first member 101. In this way, the first conveying rollers 41 hold a portion of the first member 101 therebetween. In other words, the first conveying rollers 41 nip the first member 101 therebetween. The first conveying rollers 41 nip the first member 101 therebetween at a position located between the first roll 111 and the laminating rollers 50.

Upon receiving a drive force from a conveying motor 81 (see FIG. 3), the second roller 412 rotates about an axis extending in the left-right direction. As the second roller 412 rotates, the first roller 411 also rotates about an axis extending in the left-right direction. At this time, a force is applied to the first member 101 in a direction for drawing out the first member 101 from the first roll 111. Upon receiving a drive force in the reverse direction from the conveying motor 81, the second roller 412 rotates in the reverse direction, and the first roller 411 also rotates in the reverse direction along with the rotation of the second roller 412. At this time, a force is applied to the first member 101 in a direction for bringing the first member 101 closer to the first roll 111, i.e., for taking up the first member 101 onto the first roll 111. The direction for drawing out the first member 101 from the first roll 111 is an example of the draw-out direction of the present disclosure.

The second conveying rollers 42 include a third roller 421 and a fourth roller 422. The third conveying rollers 43 include a fifth roller 431 and a sixth roller 432. The fourth conveying rollers 44 include a seventh roller 441 and an eighth roller 442. Since the second through fourth conveying rollers 42-44 have the same configuration and function as the first conveying rollers 41, a description of this configuration and function has been omitted. As with the first conveying rollers 41, each pair of the second through fourth conveying rollers 42-44 hold a portion of the first member 101 at a position located between the first roll 111 (first holder 21) and the laminating rollers 50. In other words, the second rollers 42 nip the first member 101 therebetween at a position between the first holder 21 and the laminating rollers 50, the third rollers 43 nip the first member 101 therebetween at a position between the first holder 21 and the laminating rollers 50, and the fourth rollers 44 nip the first member 101 therebetween at a position between the first holder 21 and the laminating rollers 50.

Of the pair of rollers constituting each of the first through fourth conveying rollers 41-44, the lower roller receives the drive force from the conveying motor 81 in the present embodiment. However, the upper roller may instead be configured to receive the drive force from the conveying motor 81, or both the upper and lower rollers may receive the drive force from the conveying motor 81. Furthermore, not all of the first through fourth conveying rollers 41-44 need to be configured to receive a drive force from the conveying motor 81. The first through fourth conveying rollers 41-44 may receive a drive force independently from respective separate motors, or may receive a drive force from motors that drive components other than the first through fourth conveying rollers 41-44.

### <Laminating Rollers 50>

The laminating rollers 50 are disposed downstream relative to the image recording unit 30 along the conveying path 15 in the conveying direction. The laminating rollers 50 are positioned between the first cutting unit 68 and the second cutting unit 69 in the front-rear direction. The laminating rollers 50 include a first laminating roller 51 and a second laminating roller 52. The first laminating roller 51 is disposed directly above the second laminating roller 52. The first laminating roller 51 and the second laminating roller 52 hold a portion of the first member 101 and a portion of the second member 102 therebetween with a prescribed pressure. In other words, the first laminating roller 51 and the second laminating roller 52 nip the first member 101 and the second member 102 therebetween with a prescribed pressure. Hence, the first laminating roller 51 and the second laminating roller 52 laminate a portion of the first member 101 and a portion of the second member 102 together to generate a finished laminated product 100.

The second member 102 drawn out from the second roll 112 enters between the first laminating roller 51 and the second laminating roller 52. At this time, the lamination surface 109 of the second member 102 faces downward. After passing the image recording unit 30 and the first cutting unit 68, the first member 101 enters beneath the second member 102 between the first laminating roller 51 and the second laminating roller 52. At this time, the recording surface 107 of the first member 101 faces upward.

Upon receiving a drive force from a lamination motor 78 (see FIG. 3), the second laminating roller 52 rotates about an axis extending in the left-right direction. As the second laminating roller 52 rotates, the first laminating roller 51 also rotates about an axis extending in the left-right direction. The first laminating roller 51 and the second laminating roller 52 laminate the first member 101 and the second member 102 by bringing the recording surface 107 of the first member 101 into close contact with the lamination surface 109 of the second member 102. As an alternative, the first laminating roller 51 may receive the drive force from the lamination motor 78, or both the first laminating roller 51 and the second laminating roller 52 may receive the drive force from the lamination motor 78. The laminating rollers 50 are an example of the laminating portion of the present disclosure.

### <Tension Generating Unit 60 and Slack Sensor 63>

The tension generating unit 60 is disposed downward relative to the conveying path 15 in the up-down direction and between the first conveying rollers 41 and the second conveying rollers 42 in the front-rear direction. The tension generating unit 60 includes a contact member 61, and a spring 62 that expands and contracts in the up-down direction. The lower end of the spring 62 is fixed inside the housing 11, and the upper end of the spring 62 is connected to the lower end of the contact member 61. The upper end of the contact member 61 can come into contact with the back surface 108 of the portion of the first member 101 that is positioned between the first conveying rollers 41 and the second conveying rollers 42. A tension corresponding to the restoring force of the spring 62 is applied to the first member 101 that is in contact with the contact member 61. The tension generating unit 60 generates a predetermined tension in the portion of the first member 101 that is positioned between the first conveying rollers 41 and the second conveying rollers 42. As an alternative, the contact member 61 may be configured to come into contact with the upper surface (the recording surface 107) of the first member 101.

The contact member 61 moves in the up-down direction according to the tension in the portion of the first member 101 that is positioned between the first conveying rollers 41 and the second conveying rollers 42. When the tension in the portion of the first member 101 is high, the contact member 61 is positioned relatively downward against the restoring force of the spring 62. When the tension in the portion of the first member 101 is low, the contact member 61 is positioned relatively upward by the restoring force of the spring 62. The restoring force of the spring 62 is weaker than the force that a rotary drive unit 71 (see FIG. 3) applies to the first roll 111 via the first holder 21 and weaker than the force that the conveying motor 81 applies to the first conveying rollers 41.

The slack sensor 63 is disposed near the lower end of the contact member 61 in the up-down direction. The slack sensor 63 includes a light-emitting element (not illustrated) that emits light toward the side surface of the contact member 61, and a light-receiving element (not illustrated) that receives light reflected off the side surface of the contact member 61. When the tension in the portion of the first member 101 that is positioned between the first conveying rollers 41 and the second conveying rollers 42 is high and slack in this portion of the first member 101 is small, the contact member 61 is positioned downward relative to a reference point. At this time, the light-receiving element of the slack sensor 63 receives light reflected off the side surface of the contact member 61, and the amount of light detected by the light-receiving element is greater than a threshold value. On the other hand, when the tension in the portion of the first member 101 that is positioned between the first conveying rollers 41 and the second conveying rollers 42 is low and the slack in this portion of the first member 101 is great, the contact member 61 is positioned upward relative to the reference point. At this time, the light-receiving element of the slack sensor 63 does not receive light reflected off the side surface of the contact member 61 and, hence, the amount of light detected by the light-receiving element is less than the threshold value.

The slack sensor 63 is an example of the slack sensor of the present disclosure. When the amount of slack detected by the slack sensor 63 is greater than or equal to a predetermined amount, the control unit 90 performs a slack elimination control (described later). The predetermined amount is an example of the predetermined amount of the present disclosure. During a slack elimination control by the control unit 90, the rotary drive unit 71 applies a force to the first roll 111 via the first holder 21 acting in the direction for taking up the first member 101.

### <First Cutting Unit 68>

The first cutting unit 68 is disposed downstream relative to the image recording unit 30 along the conveying path 15 in the conveying direction. The first cutting unit 68 is disposed upward relative to the conveying path 15 in the up-down direction and between the third conveying rollers 43 and the fourth conveying rollers 44 in the front-rear direction. The first cutting unit 68 cuts the first member 101 at a position located between the second conveying rollers 42 and the laminating rollers 50.

The first cutting unit 68 may have any configuration capable of cutting the first member 101. For example, the first cutting unit 68 may include a cutter carriage that moves in the left-right direction when a drive force is received from a cutting motor 85 (see FIG. 3), and a cutter mounted on the cutter carriage. Alternatively, the first cutting unit 68 may include a movable blade that moves in the up-down direction when a drive force is received from the cutting motor 85, and a fixed blade that opposes the movable blade.

### <Second Cutting Unit 69>

The second cutting unit 69 is disposed downstream relative to the laminating rollers 50 along the conveying path 15 in the conveying direction. The second cutting unit 69 is disposed upward relative to the conveying path 15 in the up-down direction and frontward relative to the laminating rollers 50 in the front-rear direction. The second cutting unit 69 simultaneously cuts the first member 101 and the second member 102, which have been laminated together by the laminating rollers 50, at a position downstream relative to the laminating rollers 50 in the conveying direction.

The second cutting unit 69 may have any configuration capable of cutting the first member 101 and the second member 102. For example, as with the first cutting unit 68, the second cutting unit 69 may include a cutter carriage that moves in the left-right direction and a cutter or may include a movable blade that moves in the up-down direction and a fixed blade that opposes the movable blade.

### <Member Sensor 64>

The member sensor 64 is disposed upward relative to the conveying path 15 in the up-down direction and between the fourth conveying rollers 44 and the laminating rollers 50 in the front-rear direction. Specifically, the member sensor 64 is disposed immediately rearward relative to the laminating rollers 50 in the front-rear direction. Furthermore, the member sensor 64 is disposed upstream relative to the laminating rollers 50 and downstream relative to the first cutting unit 68 along the conveying path 15 in the conveying direction.

The member sensor 64 includes a light-emitting element (not illustrated) that emits light toward the recording surface 107 of the first member 101 being conveyed along the conveying path 15, and a light-receiving element (not illustrated) that receives light reflected off the recording surface 107 of the first member 101. When the first member 101 is present beneath the member sensor 64, the light-receiving element of the member sensor 64 receives light reflected off the recording surface 107 of the first member 101, and the amount of light detected by the light-receiving element is greater than a threshold value. On the other hand, when the first member 101 is not present below the member sensor 64, the light-receiving element of the member sensor 64 does not receive light reflected off the recording surface 107 of the first member 101 and, hence, the amount of light detected by the light-receiving element is less than the threshold value.

The member sensor 64 is an example of the member sensor of the present disclosure. The control unit 90 detects, based on the signal outputted from the member sensor 64, the leading edge of the portion of the first member 101 that has been drawn out from the first roll 111 and the trailing edge of the portion of the first member 101 that has been drawn out from the first roll 111 and has been cut by the first cutting unit 68.

Although the member sensor 64 having the light-emitting element and the light-receiving element is disposed upward relative to the conveying path 15 in the up-down direction in the present embodiment, a member sensor 64 of the same configuration may instead be disposed downward relative to the conveying path 15 in the up-down direction. Alternatively, the member sensor 64 may be a contact sensor disposed leftward or rightward relative to the conveying path 15 in the left-right direction. In this case, the member sensor 64 may be a contact sensor that contacts the left edge or the right edge of the first member 101 to detect the edge portion of the first member 101.

### <Control Unit 90 and its Peripheral Components>

As illustrated in FIG. 3, the control unit 90 includes a CPU 91, a ROM 92, a RAM 93, an EEPROM 94, and an ASIC 95. The ROM 92 stores a program for controlling various operations of the laminating apparatus 1. The EEPROM 94 stores various data used when the CPU 91 executes the program. The RAM 93 is used as a storage area for temporarily storing various data used when the CPU 91 executes the above program, and as an area for developing data and programs. When the power to the laminating apparatus 1 is turned on, a copy of the program stored in the ROM 92 is transferred to the RAM 93. The CPU 91 executes the program stored in the RAM 93, whereby the control unit 90 performs various control.

The ASIC 95 is connected to the operation unit 12 and the display unit 13. The operation unit 12 detects when operating keys are pressed and outputs signals corresponding to the pressed operating keys. The control unit 90 identifies pressed operating keys based on the signals received from the operation unit 12. The display unit 13 displays information related to the operations of the laminating apparatus 1 on a screen based on instructions received from the control unit 90.

The ASIC 95 is also connected to the recording head 32. The control unit 90 outputs signals to the recording head 32 via the ASIC 95 based on image data. In accordance with the signals outputted from the control unit 90, the recording head 32 ejects ink from the nozzles 33 formed in the recording head 32.

The ASIC 95 is also connected to the slack sensor 63. The slack sensor 63 outputs signals corresponding to the amount of light detected by the light-receiving element of the slack sensor 63. The control unit 90 determines, based on signals outputted from the slack sensor 63, the amount of slack in the portion of the first member 101 that is positioned between the first conveying rollers 41 and the second conveying rollers 42.

The ASIC 95 is also connected to the member sensor 64. The member sensor 64 outputs signals corresponding to the amount of light detected by the light-receiving element of the member sensor 64. The control unit 90 determines, based on signals outputted from the member sensor 64, whether the first member 101 is present between the second conveying rollers 42 and the laminating rollers 50.

The ASIC 95 is also connected to a maintenance unit 86. The maintenance unit 86 cleans the recording head 32 under control of the control unit 90. The maintenance unit 86 operates upon receiving power from the conveying motor 81. Accordingly, the driving of the maintenance unit 86 is linked to the rotation of the various rollers such as the second conveying rollers 42.

### <Various Motors>

The ASIC 95 is also connected to the first roll motor 72, the second roll motor 75, the lamination motor 78, the conveying motor 81, the CR motor 84, and the cutting motor 85. The ASIC 95 has built-in drive circuits for controlling these motors. The CPU 91 outputs drive signals for rotating respective motors to the drive circuits corresponding to the respective motors. Each drive circuit outputs a drive current based on the drive signal received from the CPU 91 to the corresponding motor, causing the motor to rotate. Some of the motors described above may be configured of the same motor.

The first roll motor 72 generates power for rotating the first roll 111 supported by the first holder 21. A torque limiter 73 is interposed between the first roll motor 72 and the first holder 21. The torque limiter 73 is mounted on the rotational shaft of the first holder 21, for example. The torque limiter 73 limits the output power of the first roll motor 72 and transmits the limited power to the rotational shaft of the first holder 21. In this way, the output power of the first roll motor 72 limited by the torque limiter 73 is applied to the first roll 111 via the first holder 21. The first roll motor 72 and the torque limiter 73 function as a rotary drive unit 71.

The rotary drive unit 71 is an example of the first rotary drive portion of the present disclosure. The first roll motor 72 is an example of the motor of the present disclosure. The torque limiter 73 is an example of the torque limiter of the present disclosure. The output power of the first roll motor 72 limited by the torque limiter 73 and applied to the first roll 111 via the first holder 21 is an example of the first force of the present disclosure.

The second roll motor 75 generates power for rotating the second roll 112 supported by the second holder 22. A torque limiter 76 is interposed between the second roll motor 75 and the second holder 22. The torque limiter 76 is mounted on the rotational shaft of the second holder 22, for example. The torque limiter 76 limits the output power of the second roll motor 75 and transmits the limited power to the rotational shaft of the second holder 22. In this way, the output power of the second roll motor 75 limited by the torque limiter 76 is applied to the second roll 112 via the second holder 22. The second roll motor 75 and torque limiter 76 function as a rotary drive unit 74.

The lamination motor 78 generates power for rotating the laminating rollers 50. A torque limiter 79 is interposed between the lamination motor 78 and the laminating rollers 50. The torque limiter 79 is mounted on the rotational shaft of the second laminating roller 52, for example. The torque limiter 79 limits the output power of the lamination motor 78 and transmits the limited power to the rotational shaft of the second laminating roller 52. In this way, the output power of the lamination motor 78 limited by the torque limiter 79 is applied to the laminating rollers 50. The lamination motor 78 and torque limiter 79 function as a rotary drive unit 77.

The rotary drive unit 77 is an example of the third rotary drive portion of the present disclosure. The lamination motor 78 is an example of the motor of the present disclosure. The torque limiter 79 is an example of the torque limiter of the present disclosure. The output power of the lamination motor 78 limited by the torque limiter 79 and applied to the laminating rollers 50 is an example of the third force of the present disclosure.

The conveying motor 81 generates power for rotating the first through fourth conveying rollers 41-44. The power generated by the conveying motor 81 is applied to the second roller 412, the fourth roller 422, the sixth roller 432, and the eighth roller 442. The second roller 412, the fourth roller 422, the sixth roller 432, and the eighth roller 442 rotate about respective central axes extending in the left-right direction upon receiving power from the conveying motor 81. As a result, the first roller 411, the third roller 421, the fifth roller 431, and the seventh roller 441 also rotate about respective central axes extending in the left-right direction. The conveying motor 81 is an example of the second rotary drive portion of the present disclosure.

A rotary encoder 82 is mounted on the rotational shaft of the second roller 412. The rotary encoder 82 outputs a signal corresponding to the rotated amount of the second roller 412. The control unit 90 obtains the rotated amount of the first conveying rollers 41 based on the signal outputted from the rotary encoder 82. As an alternative, the rotary encoder 82 may be mounted on the rotational shaft of the first roller 411. The rotary encoder 82 is an example of the rotation sensor of the present disclosure.

A rotary encoder 83 is mounted on the rotational shaft of the fourth roller 422. The rotary encoder 83 outputs a signal corresponding to the rotated amount of the fourth roller 422. The control unit 90 obtains the rotated amount of the second conveying rollers 42 based on the signal outputted from the rotary encoder 83. As an alternative, the rotary encoder 83 may be mounted on the rotational shaft of the third roller 421. The rotary encoder 83 is an example of the rotation sensor of the present disclosure. The CR motor 84 generates power for moving the carriage 31 in the left-right direction. The cutting motor 85 generates power for operating the first cutting unit 68 and the second cutting unit 69.

The control unit 90 drives the conveying motor 81 to rotate the first through fourth conveying rollers 41-44 and drives the rotary drive unit 77 to rotate the laminating rollers 50. The control unit 90 drives the rotary drive unit 71 to apply a force to the first roll 111 via the first holder 21 and drives the rotary drive unit 74 to apply a force to the second roll 112 via the second holder 22. The control unit 90 drives the CR motor 84 to move the carriage 31 and drives the cutting motor 85 to operate the first cutting unit 68 and the second cutting unit 69.

### <Motors Related to First Member 101>

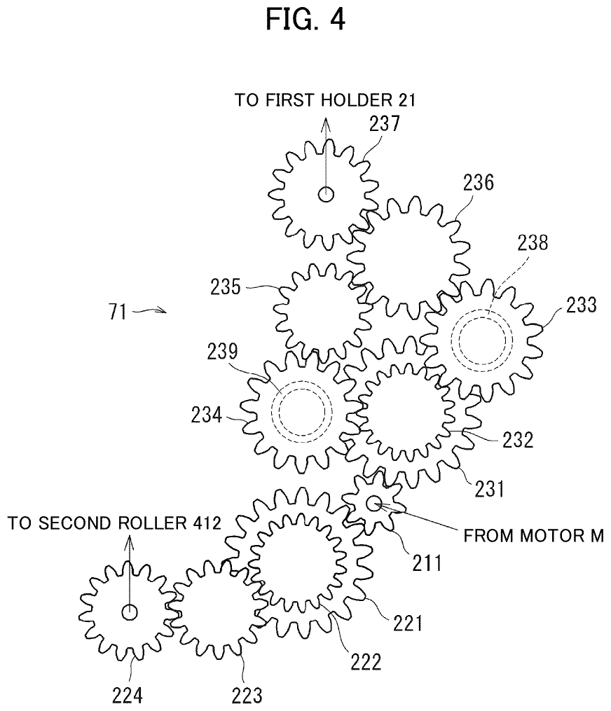

The first roll motor 72 generates a force acting in a direction for taking up the first member 101 onto the first roll 111. The conveying motor 81 selectively generates a force acting in a direction for drawing out the first member 101 from the first roll 111 and a force acting in a direction for taking up the first member 101 onto the first roll 111. The first roll motor 72 and the conveying motor 81 may be implemented as separate motors, for example. In this case, the control unit 90 controls the first roll motor 72 and the conveying motor 81 separately. The first roll motor 72 and the conveying motor 81 may also be implemented using the same motor (see FIG. 4). In this case, the control unit 90 controls the motor that functions as both the first roll motor 72 and the conveying motor 81 (hereinafter referred to as motor M).

FIG. 4 illustrates a gear train provided when the first roll motor 72 and the conveying motor 81 are implemented using the same motor M. As illustrated in FIG. 4, the gear train includes gears 211, 224, and 237. The gear 211 is mounted on the rotational shaft of the motor M. The gear 224 is mounted on the rotational shaft of the second roller 412. The gear 237 is mounted on the rotational shaft of the first holder 21. Note that FIG. 4 schematically illustrates the gear train and does not accurately depict the arrangement and sizes of the gears and the geometry of the gear teeth, for example.

As illustrated in FIG. 4, the gear train also includes gears 221-223 and 231-236, and one-way clutches 238 and 239. The gear 211 meshes with the gears 221 and 231. The gear 223 meshes with the gear 222 having the same rotational axis as the gear 221, and the gear 224. The gear 232, which has the same rotational axis as the gear 231, meshes with the gears 233 and 234. The gear 234 meshes with the gear 235. The gear 236 meshes with the gears 233, 235, and 237. The one-way clutch 238 is mounted on the gear 233. The one-way clutch 238 transmits rotation in only one direction. The one-way clutch 239 is mounted on the gear 234. The one-way clutch 239 transmits rotation in only the other direction. The rotary drive unit 71 includes the gears 231-237 and the one-way clutches 238 and 239.

When the control unit 90 drives the motor M so that the gear 211 rotates counterclockwise in FIG. 4, the gear 224 and the second roller 412 rotate clockwise in FIG. 4. In this case, the gear 233 rotates counterclockwise in FIG. 4, while the gear 234 does not rotate due to the function of the one-way clutch 239. Accordingly, the gear 237, the first holder 21, and the first roll 111 rotate counterclockwise in FIG. 4.

When the control unit 90 drives the motor M in reverse so that the gear 211 rotates clockwise in FIG. 4, the gear 224 and the second roller 412 rotate counterclockwise in FIG. 4. In this case, the gear 234 rotates clockwise in FIG. 4, while the gear 233 does not rotate due to the function of the one-way clutch 238. Accordingly, the gear 237, the first holder 21, and the first roll 111 rotate counterclockwise in FIG. 4.

According to the configuration illustrated in FIG. 4, the same motor can be used to implement the first roll motor 72 that generates a force acting in the direction for taking up the first member 101, and the conveying motor 81 that selectively generates a force acting in the direction for drawing out the first member 101 and a force acting in the direction for taking up the first member 101.

A different configuration from that described above may be used when implementing the first roll motor 72 and the conveying motor 81 with the same motor. For example, a clutch may be arranged between a motor that rotates both forward and in reverse and the first holder 21, and the rotating direction of the first holder 21 may be switched with the clutch.

### <Laminating Process by Control Unit 90>

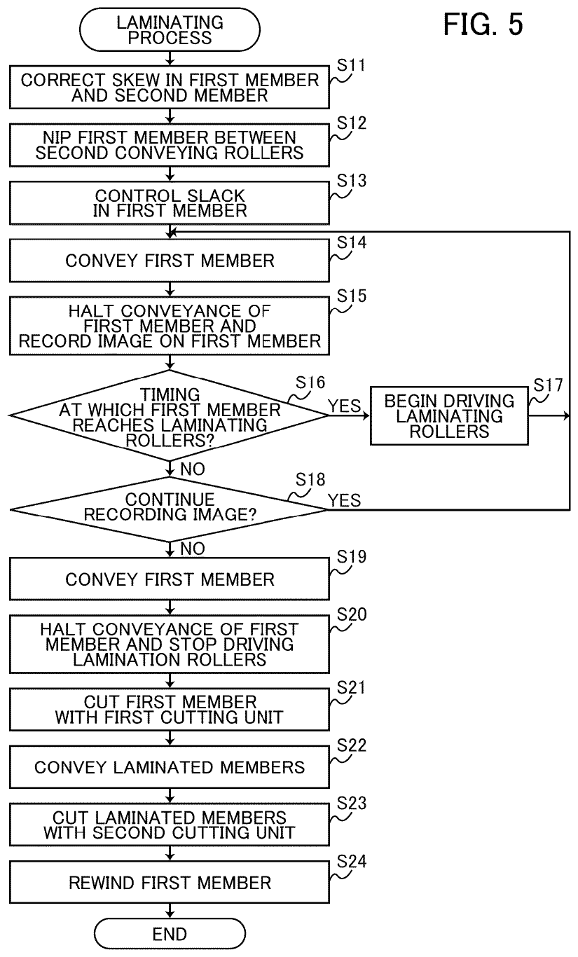

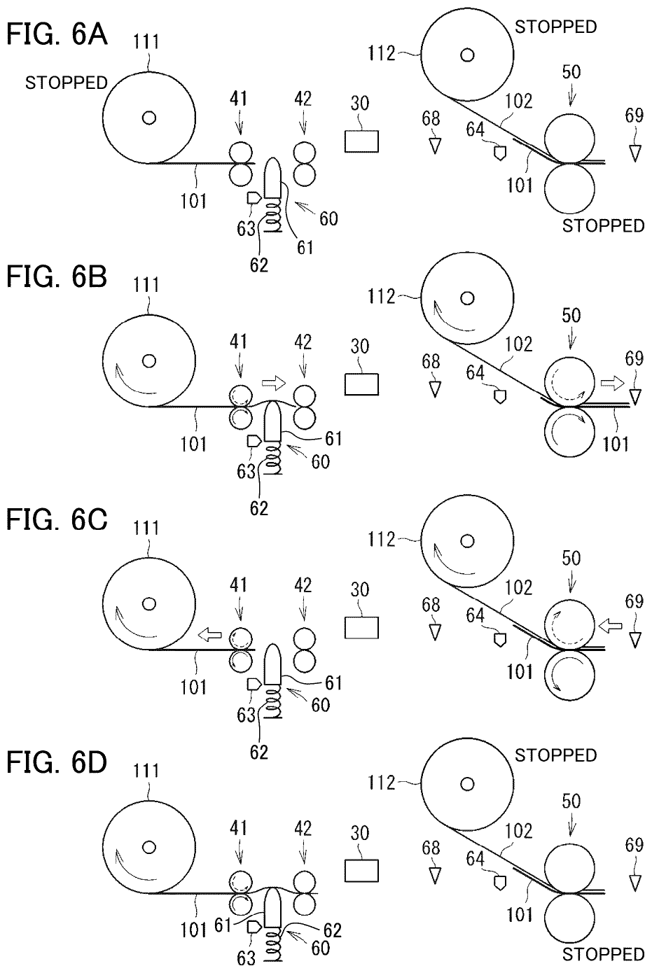

A laminating process performed by the control unit 90 will be described next with reference to FIG. 5. To perform the laminating process in FIG. 5, the control unit 90 executes a program stored in the RAM 93. When receiving an instruction to execute a laminating process from the operation unit 12, for example, the control unit 90 executes the laminating process. As the control unit 90 executes the laminating process, the laminating apparatus 1 operates as illustrated in FIGS. 6A through 8D. Note that only main components of the laminating apparatus 1 are illustrated in FIGS. 6A through 8D. Furthermore, descriptions related to the third conveying rollers 43 and the fourth conveying rollers 44 have been omitted below since the third conveying rollers 43 and the fourth conveying rollers 44 play only a minor role in the laminating process.

FIG. 6A illustrates the initial state of the laminating apparatus 1 prior to initiating the laminating process. In the initial state, the first roll 111 (the first holder 21), the second roll 112 (the second holder 22), and the laminating rollers 50 are halted (stopped) by the control unit 90. Also, in this initial state, the leading edge of the portion of the first member 101 drawn out from the first roll 111 is nipped between the first conveying rollers 41 while the leading edge of the portion of the second member 102 drawn out from the second roll 112 is nipped between the laminating rollers 50. Additionally, the remainder of the first member 101 generated in the previous laminating process remains nipped between the laminating rollers 50.

When starting to use the laminating apparatus 1, the user mounts the first roll 111 on the first holder 21 and mounts the second roll 112 on the second holder 22. The user then draws out the first member 101 from the first roll 111 and causes the leading edge of the drawn-out portion of the first member 101 to be nipped between the first conveying rollers 41. The user also draws out the second member 102 from the second roll 112 and causes the leading edge of the drawn-out portion of the second member 102 to be nipped between the laminating rollers 50. Through these operations, the laminating apparatus 1 is placed in the initial state illustrated in FIG. 6A. In this case, however, no remainder of the first member 101 generated in the previous laminating process is nipped between the laminating rollers 50.

### <Skew Correction for First Member 101 and Second Member 102>

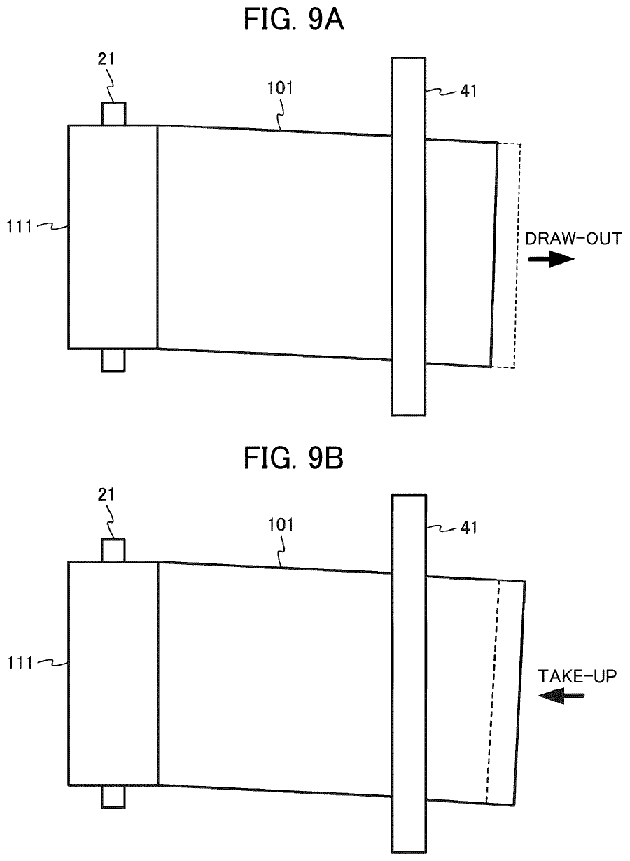

In S11 at the beginning of the laminating process, the control unit 90 corrects any skew in the first member 101 and the second member 102. Specifically, the control unit 90 drives the conveying motor 81 to perform a draw-out process for the first member 101 in S11. In the draw-out process for the first member 101, the conveying motor 81 applies a force to the first conveying rollers 41 acting in the direction for drawing out the first member 101 (see FIGS. 6B and 9A). At this time, the rotary drive unit 71 applies, via the first holder 21, a force to the first roll 111 acting in the direction for taking up the first member 101. However, since the latter force (that is, the force acting in the direction for taking up the first member 101) is smaller than the former (that is, the force acting in the direction for drawing out the first member 101), the first member 101 is drawn out toward the downstream side of the conveying path 15 in the conveying direction.

Following the draw-out process for the first member 101, the control unit 90 performs a take-up process for the first member 101. In the take-up process for the first member 101, the control unit 90 drives the conveying motor 81 in the reverse direction to apply a force to the first conveying rollers 41 acting in the direction for taking up the first member 101 (see FIGS. 6C and 9B). At this time, the rotary drive unit 71 continues to apply, via the first holder 21, a force to the first roll 111 acting in the direction for taking up the first member 101. Accordingly, part of the portion of the first member 101 that has been drawn out is taken up onto the first roll 111.

In the draw-out process for the first member 101, the control unit 90 draws out the first member 101 to an extent that the leading edge of the first member 101 does not reach the second conveying rollers 42. In the take-up process for the first member 101, the control unit 90 takes up the first member 101 to an extent that the leading edge of the first member 101 does not come out from between the first conveying rollers 41. The control unit 90 corrects skew in the first member 101 by performing the draw-out process and the take-up process once each, for example.

When performing the draw-out process and the take-up process for the first member 101, the control unit 90 drives the first roll motor 72 and the conveying motor 81. However, when the first roll motor 72 and the conveying motor 81 are implemented using the same motor, the control unit 90 drives only that single motor.

In addition to the above processes, in S11 the control unit 90 also drives the lamination motor 78 to perform a draw-out process for the second member 102. In the draw-out process for the second member 102, the lamination motor 78 applies a force to the laminating rollers 50 acting in the direction for drawing out the second member 102 from the second roll 112 (see FIG. 6B). At this time, the rotary drive unit 74 applies, via the second holder 22, a force to the second roll 112 acting in the direction for taking up the second member 102 onto the second roll 112. However, since the latter force (that is, the force acting in the direction for taking up the second member 102) is smaller than the former (that is, the force acting in the direction for drawing out the second member 102), the second member 102 is drawn out toward the laminating rollers 50.

Following this draw-out process for the second member 102, the control unit 90 performs a take-up process for the second member 102. In the take-up process for the second member 102, the control unit 90 drives the lamination motor 78 in the reverse direction to apply a force to the laminating rollers 50 acting in the direction for taking up the second member 102 (see FIG. 6C). At this time, the rotary drive unit 74 continues to apply, via the second holder 22, a force to the second roll 112 acting in the direction for taking up the second member 102. Accordingly, part of the portion of the second member 102 that has been drawn out is taken up onto the second roll 112.

In the take-up process for the second member 102, the control unit 90 takes up the second member 102 to an extent that the leading edge of the second member 102 does not come out from between the laminating rollers 50. The control unit 90 corrects skew in the second member 102 by performing the draw-out process and the take-up process once each, for example.

When performing the draw-out process and the take-up process for the second member 102, the control unit 90 drives the second roll motor 75 and the lamination motor 78. However, when the second roll motor 75 and the lamination motor 78 are implemented using the same motor, the control unit 90 drives only that single motor.

When the user causes the leading edge of the portion of the first member 101 that has been drawn out from the first roll 111 to be nipped between the first conveying rollers 41, the drawn-out portion of the first member 101 may be nipped between the first conveying rollers 41 in an oblique direction to the conveying direction, as illustrated in FIG. 9A. In this case, the control unit 90 can correct the skew in the drawn-out portion of the first member 101 by alternately performing the draw-out process (FIG. 9A) and the take-up process (FIG. 9B) for the first member 101. The control unit 90 can also correct skew in the drawn-out portion of the second member 102 according to the same method.

In S11 the control unit 90 performs skew correction for the first member 101 and skew correction for the second member 102 in parallel. However, the control unit 90 may execute skew correction for one of the first member 101 and the second member 102 first before executing skew correction for the other.

The control unit 90 may also perform skew correction for the first member 101 by alternating the draw-out process and the take-up process a plurality of times (e.g., ten times each). Furthermore, the control unit 90 need not drive the conveying motor 81 to apply a force to the first conveying rollers 41 from the conveying motor 81 when performing the take-up process for the first member 101. The control unit 90 may also drive the conveying motor 81 to apply a force to the first conveying rollers 41 that acts in the direction for drawing out the first member 101 and that is smaller than the force acting on the first roll 111 via the first holder 21 when performing the take-up process for the first member 101. The same variations may be applied to skew correction for the second member 102.

The control unit 90 performs skew correction for the first member 101 after the first roll 111 has been mounted on the first holder 21 and before the first member 101 has been nipped between the laminating rollers 50. Furthermore, the control unit 90 performs skew correction for the first member 101 while the first member 101 is not nipped between the second conveying rollers 42. The process of S11 is an example of the skew correction control of the present disclosure.

<Nipping First Member 101 Between Second Conveying Rollers 42>

In S12 the control unit 90 causes the first member 101 to be nipped between the second conveying rollers 42. Specifically, in S12 the control unit 90 stops driving the lamination motor 78 and the second roll motor 75 to halt the laminating rollers 50 and the second holder 22 together with the second roll 112, respectively. Subsequently, the control unit 90 drives the conveying motor 81 to apply a force to the first conveying rollers 41 acting in the direction for drawing out the first member 101. At this time, the rotary drive unit 71 continues to apply, via the first holder 21, a force to the first roll 111 acting in the direction for taking up the first member 101. Since the latter force (that is, the force acting in the direction for taking up the first member 101) is smaller than the former (that is, the force acting in the direction for drawing out the first member 101), the first member 101 is drawn out toward the downstream side of the conveying path 15 in the conveying direction while remaining a certain tension. When the leading edge of the drawn-out portion of the first member 101 reaches the second conveying rollers 42, the second conveying rollers 42 nip the drawn-out portion of the first member 101 therebetween (see FIG. 6D).

The control unit 90 also receives an output signal from the rotary encoder 82 in S12. This signal indicates the rotated amount of the first conveying rollers 41. The control unit 90 drives, based on output signal from the rotary encoder 82, the conveying motor 81 until the rotated amount of the first conveying rollers 41 reaches a predetermined amount. Thus, when conveying the first member 101 toward the second conveying rollers 42, the control unit 9 determines the conveyance amount of the first member 101 based on the rotated amount of the first conveying rollers 41 detected by the rotary encoder 82.

The control unit 90 executes the process of S12 while the first member 101 is not nipped between the second conveying rollers 42. The conveyance of the first member 101 in S12 is an example of the first conveyance control of the present disclosure. When control unit 90 performs the first conveyance control, the rotary drive unit 71 applies a force, via the first holder 21, to the first roll 111 acting in the direction for taking up the first member 101.

### <Slack Control for First Member 101>

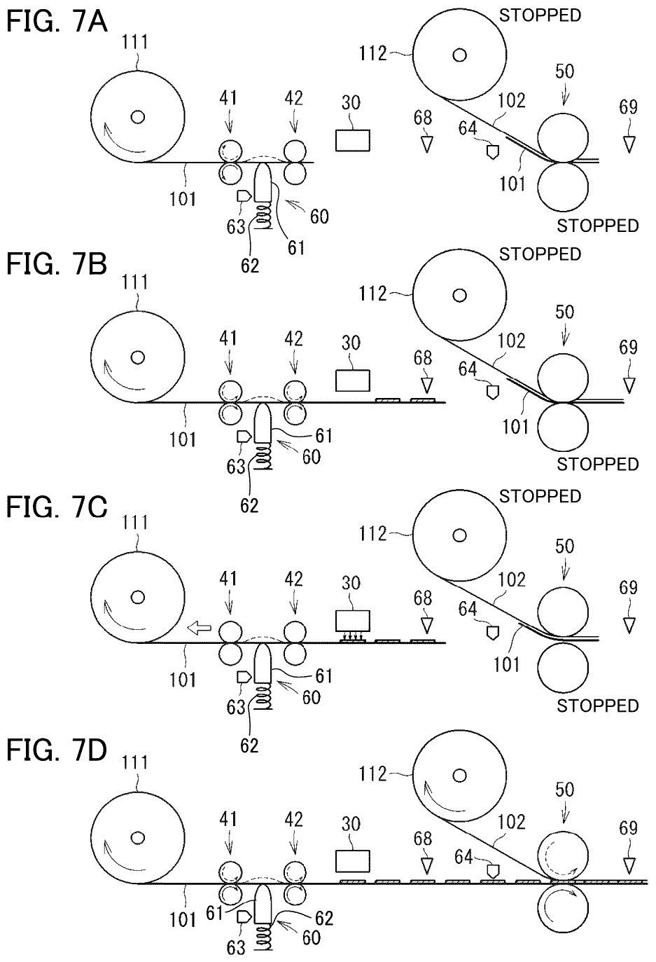

In S13 the control unit 90 controls the slack in the first member 101. After the process in S12, the first member 101 is nipped between the second conveying rollers 42 in a slackened state. Thus, in S13 the control unit 90 drives the conveying motor 81 in the reverse direction to rotate the first conveying rollers 41 in the reverse direction while maintaining the second conveying rollers 42 in a halted state (see FIG. 7A). This action conveys the portion of the first member 101 between the first conveying rollers 41 and the second conveying rollers 42 away from the second conveying rollers 42. In other words, this action conveys the first member 101 in the direction for taking up the first member 101. At this time, the slack in the portion of the first member 101 draped over the tension generating unit 60 is eliminated, at which time the first member 101 pushes the contact member 61 of the tension generating unit 60 downward. This in turn causes the spring 62, which expands and contracts in the up-down direction, to contract. In this state, the contact member 61 applies upward pressure to the first member 101, generating tension in the portion of the first member 101 between the first conveying rollers 41 and the second conveying rollers 42.

The control unit 90 also receives an output signal from the slack sensor 63 in S13. The control unit 90 determines, based on the output signal from the slack sensor 63, the amount of slack in the portion of the first member 101 between the first conveying rollers 41 and the second conveying rollers 42 detected by the slack sensor 63. When the slack in the first member 101 drops to a predetermined amount, the control unit 90 stops driving the conveying motor 81 in reverse, thereby halting the first conveying rollers 41. This process reduces slack in the portion of the first member 101 between the first conveying rollers 41 and the second conveying rollers 42.

The control unit 90 executes the process in S13 after the first member 101 is nipped between the second conveying rollers 42. In other words, the control unit 90 executes the process in S13 in a state where the first member 101 is nipped between the second conveying rollers 42. The process in S13 is an example of the slack elimination control of the present disclosure. The rotary drive unit 71 continues to apply, via the first holder 21, a force to the first roll 111 acting in the direction for taking up the first member 101 even when the control unit 90 is performing a slack elimination control.

### <Conveyance of and Image Recording on First Member 101>

Next, in S14 the control unit 90 conveys the first member 101. Specifically, the control unit 90 drives the conveying motor 81 to rotate the first conveying rollers 41 and the second conveying rollers 42, thereby causing the first conveying rollers 41 and the second conveying rollers 42 to convey the first member 101 (see FIG. 7B). The process of S14 is an example of the second conveyance control in the present disclosure. The second conveyance control causes both the first conveying rollers 41 and the second conveying rollers 42 to simultaneously convey the first member 101.

The control unit 90 also receives an output signal from the rotary encoder 83 in S14. This signal indicates the rotated amount of the second conveying rollers 42. The control unit 90 drives, based on the output signal from the rotary encoder 83, the conveying motor 81 until the rotated amount of the second conveying rollers 42 reaches a predetermined amount. In this way, the control unit 90 determines, based on the rotated amount of the second conveying rollers 42 detected by the rotary encoder 83, the conveyance amount of the first member 101 when conveying the first member 101 toward the laminating rollers 50. The control unit 90 also controls the drive force of the conveying motor 81 based on the output signal from the rotary encoder 83 in order to maintain the conveyance speed of the first member 101 at a constant level.

In S14 the control unit 90 controls the speed at which the second conveying rollers 42 convey the first member 101 to be slower than the speed at which the first conveying rollers 41 convey the first member 101. Consequently, the slack in the portion of the first member 101 between the first conveying rollers 41 and the second conveying rollers 42 increases over time. In S14 the control unit 90 also obtains the slack in the portion of the first member 101 between the first conveying rollers 41 and the second conveying rollers 42, as detected by the slack sensor 63. When the slack in the portion of the first member 101 reaches a predetermined amount, the control unit 90 stops the drive force of the conveying motor 81 from being transmitted to the first conveying rollers 41 while continuing to transmit the drive force of the conveying motor 81 to the second conveying rollers 42. In this way, the control unit 90 can reduce slack in the portion of the first member 101 between the first conveying rollers 41 and the second conveying rollers 42 even during the process of S14.

Note that if the slack in the portion of the first member 101 between the first conveying rollers 41 and the second conveying rollers 42 were to be completely eliminated, the force acting on the first roll 111 via the first holder 21 could adversely affect the operation of the first conveying rollers 41, decreasing conveyance precision for the first member 101. To improve conveyance precision for the first member 101, the control unit 90 performs a control to maintain the slack in the portion of the first member 101 between the first conveying rollers 41 and the second conveying rollers 42 at a predetermined amount.

In S15 the control unit 90 halts conveyance of the first member 101 and drives the image recording unit 30 to record an image on the first member 101. Specifically, in S15 the control unit 90 stops driving the conveying motor 81 to halt rotation of the first conveying rollers 41 and the second conveying rollers 42, thereby stopping conveyance of the first member 101. While the conveyance of the first member 101 is halted, the image recording unit 30 is controlled to eject ink from the recording head 32 onto the recording surface 107 of the first member 101, thereby recording an image on a portion of the recording surface 107 of the first member 101 (see FIG. 7C).

Thus, the control unit 90 performs a second conveyance control to convey the first member 101 to the image recording unit 30 and then drives the image recording unit 30 to record an image on the first member 101 while maintaining the first member 101 in a halted state without performing a second conveyance control.

While the control unit 90 determines in S16 described later that the first member 101 has not yet reached the laminating rollers 50 (S16: NO), in S18 the control unit 90 determines whether to continue recording images. When the control unit 90 determines that additional image data remains to be recorded, i.e., that image recording is to be continued (S18: YES), the process returns to S14. The control unit 90 repeatedly executes S14 and S15 described above until reaching a NO determination in S18. In this way, images are sequentially recorded on the first member 101 from the downstream side to the upstream side of the conveying direction. Each shaded area on the first member 101 in FIG. 7B and other drawings denotes an area where the image recording unit 30 has recorded an image in one image recording operation.

### <Driving Laminating Rollers 50>

After completing the process in S15, in S16 the control unit 90 determines whether the timing at which the first member 101 reaches the laminating rollers 50 has been reached. Specifically, in S16 the control unit first determines, based on the output signal from the member sensor 64, that the leading edge of the first member 101 is present between the second conveying rollers 42 and the laminating rollers 50, and then determines that the timing at which the leading edge of the first member 101 reaches the laminating rollers 50 has been reached when determining that the rotated amount of the second conveying rollers 42 reaches the predetermined amount on the basis of the output signal from the rotary encoder 83.

When the control unit 90 determines that the timing at which the leading edge of the first member 101 reaches the laminating rollers 50 has been reached (S16: YES), the process advances to S17. In S17 the control unit 90 begins driving the laminating rollers 50. Specifically, in S17 the control unit 90 simultaneously begins driving the lamination motor 78 and driving the second roll motor 75. The control unit 90 then returns to S14. Note that the control unit 90 reaches a YES determination in S16 only once in a single laminating process.

Following the execution of S17, the control unit 90 continues to drive the lamination motor 78 in order to apply a force to the laminating rollers 50 acting in the direction for drawing out the second member 102. At this time, the rotary drive unit 74 applies, via the second holder 22, a force to the second roll 112 acting in the direction for taking up the second member 102 (see FIG. 7D). Following the execution of S17, the laminating rollers 50 bond the recording surface 107 of the first member 101 to the lamination surface 109 of the second member 102.

Following the execution of S17, the control unit 90 also controls the speed at which the laminating rollers 50 convey the first member 101 to be faster than the speed at which the second conveying rollers 42 convey the first member 101. Therefore, even though the first member 101 is slackened when arriving at the laminating rollers 50, the slack is immediately eliminated.

After the control unit 90 has executed S17, the laminating rollers 50 apply a force to the first member 101 acting in the direction for drawing out the first member 101. In the meantime, the first member 101 remains nipped between the second conveying rollers 42 and the second conveying rollers 42 may at times be rotating and at times are halted. When the second conveying rollers 42 are in a halted state, the second conveying rollers 42 apply a force to the first member 101 for stopping conveyance of the first member 101. The force with which the second conveying rollers 42 halt conveyance of the first member 101 is stronger than the force with which the laminating rollers 50 convey the first member 101. Hence, when the second conveying rollers 42 are in the halted state, the first member 101 remains halted even when receiving the force from the laminating rollers 50. Furthermore, the force with which the second conveying rollers 42 prevents the first member 101 from being conveyed more than a predetermined amount is stronger than the force with which the laminating rollers 50 convey the first member 101. The conveying motor 81 may be a motor that either consumes power or does not consume power when the second conveying rollers 42 stop conveyance of the first member 101.

Thus, after the first member 101 reaches the laminating rollers 50, the control unit 90 alternately performs conveyance control for conveying the first member 101 and stopping control for halting conveyance of the first member 101. While performing stopping control, the control unit 90 also performs a control for driving the image recording unit 30 to record an image on the first member 101. During conveyance control, the control unit 90 controls the second conveying rollers 42 to convey the first member 101 while driving the rotary drive unit 77 to apply a force to the laminating rollers 50. While the second conveying rollers 42 are halted during stopping control, the control unit 90 drives the rotary drive unit 77 to apply a force to the laminating rollers 50.

<Cutting with First Cutting Unit 68>

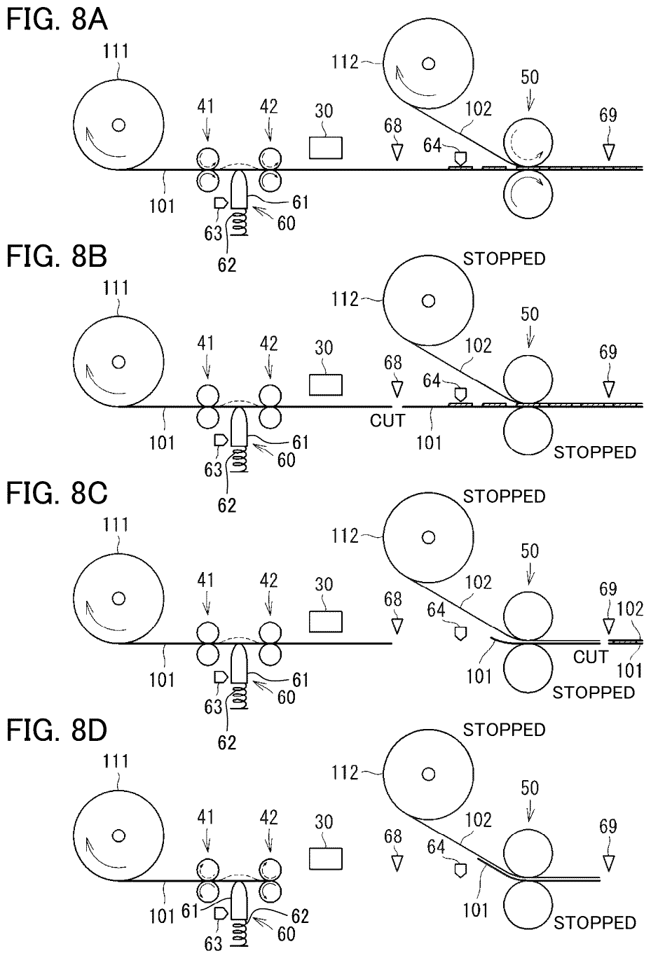

When the control unit 90 determines in S18 that image recording is not to be continued (S18: NO), the process advances to S19. In S19 the control unit 90 conveys the first member 101 until a cutting position of the first member 101 has reached beneath the first cutting unit 68. The cutting position is positioned upstream relative to the position (area) at which the image has been recorded on the first member 101. Specifically, in S19 the control unit 90 performs the same process described in S14. However, since the laminating rollers 50 are rotating in S19, the first member 101 is conveyed by both the force from the second conveying rollers 42 and the force from the laminating rollers 50 (see FIG. 8A).

After the control unit 90 has completed S19, a portion of the first member 101, which has been drawn out from and remains connected to the first roll 111, and a portion of the second member 102, which has been drawn out from and remains connected to the second roll 112, are both nipped between the laminating rollers 50. In S20 the control unit 90 halts conveyance of the first member 101 and stops driving the laminating rollers 50. Specifically, the control unit 90 stops driving the conveying motor 81, thereby halting rotation of the first conveying rollers 41 and the second conveying rollers 42 and halting conveyance of the first member 101. In addition, the control unit 90 stops driving the lamination motor 78 and driving the second roll motor 75, thereby halting rotation of the laminating rollers 50 and rotation of the second holder 22 together with the second roll 112 and halting conveyance of the second member 102. Thus, in S20 the control unit 90 stops driving the conveying motor 81 and the rotary drive units 74 and 77.

In S21 the control unit 90 causes the first member 101 to be cut by the first cutting unit 68. Specifically, in S21 the control unit 90 drives the cutting motor 85 to operate the first cutting unit 68. The first cutting unit 68 cuts the first member 101 at the cutting position of the first member 101 (see FIG. 8B).

When the cutting unit 68 cuts the first member 101 while the laminating rollers 50 are applying a force to the first member 101, the force may act only on one side of the first member 101 in the left-right direction during cutting. As a result, the position of the first member 101 may shift, causing the first member 101 to be cut obliquely. To prevent the first member 101 from being cut obliquely, the control unit 90 controls the first cutting unit 68 to cut the first member 101 after halting the laminating rollers 50 and the second roll 112.

<Cutting with Second Cutting Unit 69>

In S22 the control unit 90 conveys the first member 101 and the second member 102 after the first member 101 and the second member 102 have been laminated. Specifically, in S22 the control unit 90 drives the lamination motor 78 to convey the laminated first member 101 and second member 102 until the cutting position of the laminated first member 101 and second member 102 reaches a position beneath the second cutting unit 69.

In a case where the lamination motor 78 is a stepping motor, the control unit 90 applies a predetermined number of pulses to the lamination motor 78 after determining, based on the output signal from the member sensor 64, that the cut trailing edge of the first member 101 is present between the second conveying rollers 42 and the laminating rollers 50. Through this process, the control unit 90 can convey the laminated first member 101 and second member 102 to a position at which the laminated first member 101 and second member 102 are to be cut by the second cutting unit 69, i.e., a predetermined position beneath the second cutting unit 69.

In a case where the lamination motor 78 is a DC motor, a rotary encoder is mounted on the second laminating roller 52. The control unit 90 controls, based on the output signal from the rotary encoder, the rotated amount of the laminating rollers 50 after determining, based on the output signal from the member sensor 64, that the trailing edge of the first member 101 is present between the second conveying rollers 42 and the laminating rollers 50. Through this process, the control unit 90 can convey the laminated first member 101 and second member 102 to the position at which the laminated first member 101 and second member 102 are to be cut by the second cutting unit 69, i.e., the predetermined position beneath the second cutting unit 69.

After completing S22, the control unit 90 halts the first conveying rollers 41, the second conveying rollers 42, the laminating rollers 50, and the second roll 112. At this time point, the cutting position of the laminated first member 101 and second member 102 is positioned beneath the second cutting unit 69.

In S23 the control unit 90 causes the laminated first member 101 and second member 102 to be cut by the second cutting unit 69. Specifically, in S23 the control unit 90 drives the cutting motor 85 to operate the second cutting unit 69. The second cutting unit 69 cuts the laminated first member 101 and second member 102 at the cutting position of the laminated first member 101 and second member 102 (see FIG. 8C).

### <Rewinding First Member 101>

In S24 the control unit 90 rewinds the first member 101 onto the first roll 111.

Specifically, in S24 the control unit 90 drives the conveying motor 81 in the reverse direction to rotate the first conveying rollers 41 and the second conveying rollers 42 in the reverse direction. Accordingly, the first conveying rollers 41 and the second conveying rollers 42 apply a force to the first member 101 in a direction for taking up the first member 101. At this time, the rotary drive unit 71 is also applying, via the first holder 21, a force to the first roll 111 in the direction for taking up the first member 101. Therefore, the first member 101 is conveyed toward the first roll 111 and taken up onto the first roll 111 (see FIG. 8D).

In S24 the control unit 90 conveys the first member 101 so that the leading edge of the first member 101 is positioned upstream relative to the image recording unit 30 in the conveying direction. The control unit 90 preferably conveys the first member 101 so that the leading edge of the first member 101 is positioned between the first conveying rollers 41 and the second conveying rollers 42. This can prevent deterioration of the portion of the first member 101 that remains continuously nipped between the second conveying rollers 42. However, the control unit 90 may halt the first member 101 when the leading edge of the first member 101 is positioned downstream relative to the second conveying rollers 42 in the conveying direction. That is, the first member 101 may be stopped so that the first member 101 continues to be nipped between the second conveying rollers 42. In this case, the control unit 90 may perform a control so that image recording is not performed on the portion of the first member 101 that had remained nipped between the second conveying rollers 42. With this method, the slack elimination control for eliminating slack generated when the first member 101 is nipped again between the second conveying rollers 42 can be omitted, thereby enabling the next image recording operation to be started more quickly. After completing S24, the control unit 90 ends the laminating process.

### <Detailed Description of Conveyance of First Member 101>

The first member 101 is nipped between the first conveying rollers 41, the second conveying rollers 42, the third conveying rollers 43, the fourth conveying rollers 44, and the laminating rollers 50. Of these rollers, the second conveying rollers 42 nip the first member 101 with the strongest force. The reason for this is to prevent the first member 101 from slipping under the influence of the conveyance forces of the other rollers, thereby preventing positional deviation. This configuration improves accuracy in the conveyance amount detected by the rotary encoder 83. Additionally, the force applied to the first roll 111 via the first holder 21 and the force applied to the laminating rollers 50 are limited by torque limiters 73 and 79, whereas the force applied to the second conveying rollers 42 is not limited by any torque limiter.

After the control unit 90 begins driving the laminating rollers 50 in S17, a force acting in the direction for drawing out the first member 101 is applied to the laminating rollers 50 until the driving of the laminating rollers 50 is halted in S20. However, the force applied to the laminating rollers 50 is limited by the torque limiter 79 and is weaker than the force with which the second conveying rollers 42 convey the first member 101. Therefore, even though a force acting in the direction for drawing out the first member 101 is applied to the laminating rollers 50, the first member 101 is not conveyed while the second conveying rollers 42 are halted. The first member 101 is conveyed at a conveying speed corresponding to the rotation of the second conveying rollers 42 when the second conveying rollers 42 are rotating and is not conveyed while the second conveying rollers 42 are halted. In other words, the torque limiter 79 for the laminating rollers 50 is set so that the conveyance amount and the conveyance speed of the first member 101 is controlled by the driving of the second conveying rollers 42. When the laminating rollers 50 are driven to convey the first member 101 nipped between the second conveying rollers 42, the force applied to the laminating rollers 50 is limited by the torque limiter 79 and, hence, the rotational speed of the laminating rollers 50 is also limited.

Thus, even when the laminating rollers 50 are being driven, the first member 101 is not conveyed and the second member 102 is not also conveyed as long as the second conveying rollers 42 are in a halted state. In S15 an image is recorded on the first member 101 while the first member 101 and the second member 102 are in a halted state with a predetermined tension applied to the first member 101 and the second member 102. In S14, on the other hand, the first member 101 is conveyed with a tension different from that applied in the halted state. As described above, the speed at which the laminating rollers 50 attempt to convey the first member 101 is faster than the speed at which the second conveying rollers 42 convey the first member 101. Therefore, slack is not generated in the portion of the first member 101 between the second conveying rollers 42 and the laminating rollers 50 after the control unit 90 has executed S17.

### <Maintenance Process Executed by Control Unit 90>

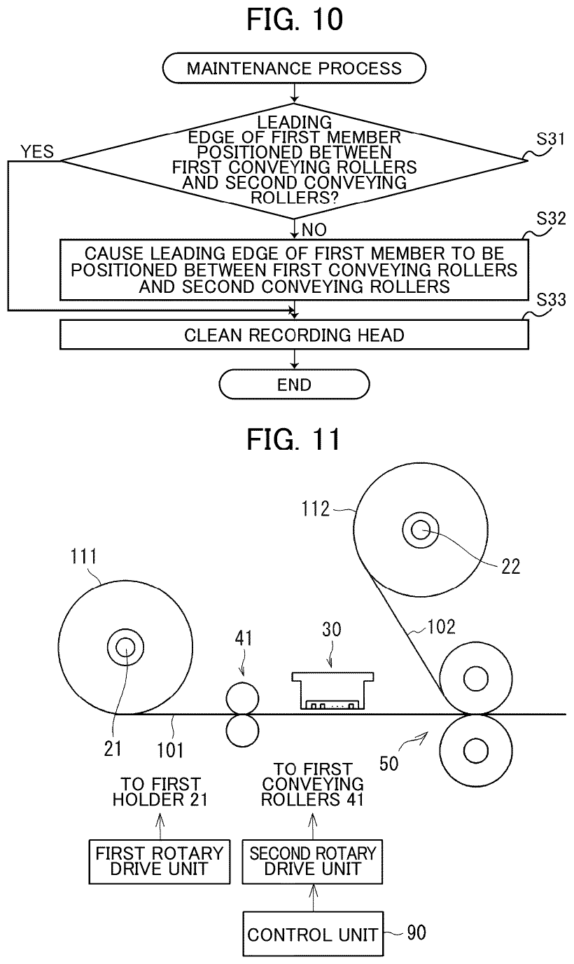

A maintenance process executed by the control unit 90 will be described with reference to FIG. 10. The control unit 90 executes this maintenance process upon receiving an instruction to execute the maintenance process from the operation unit 12 or when the control unit 90 determines that the maintenance process is to be executed, for example.

In S31 at the beginning of the maintenance process, the control unit 90 determines whether the leading edge of the first member 101 is positioned between the first conveying rollers 41 and the second conveying rollers 42. Specifically, the control unit 90 obtains the position of the leading edge of the first member 101 based on the details of processing performed prior to the maintenance process and output signals from the rotary encoders 82 and 83, for example, and determines whether the obtained position is located between the first conveying rollers 41 and the second conveying rollers 42 in the conveying direction.

When the control unit 90 determines that the leading edge of the first member 101 is positioned between the first conveying rollers 41 and the second conveying rollers 42 (S31: YES), the control unit 90 skips S32 and advances directly to S33. When the control unit 90 determines that the leading edge of the first member 101 is not positioned between the first conveying rollers 41 and the second conveying rollers 42 (S31: NO), the control unit 90 advances to S32.

In the latter case, in S32 the control unit 90 causes the first member 101 to be positioned between the first conveying rollers 41 and the second conveying rollers 42. Specifically, in S32 the control unit 90 drives the conveying motor 81 to rotate the first conveying rollers 41 and the second conveying rollers 42 in order to convey the first member 101 until the leading edge of the first member 101 is positioned between the first conveying rollers 41 and the second conveying rollers 42.

After completing the process of S32 or when reaching a YES determination in S31, in S33 the control unit 90 cleans the recording head 32. Specifically, in S33 the control unit 90 drives the maintenance unit 86 to clean the recording head 32 mounted on the carriage 31. Subsequently, the control unit 90 ends the maintenance process.

Thus, the control unit 90 performs a control to drive the maintenance unit 86 to clean the recording head 32 in a state where the leading edge of the first member 101 is positioned between the first conveying rollers 41 and the second conveying rollers 42.

### Effects of the Embodiment

As indicated above, the laminating apparatus 1 according to the present embodiment includes the first holder 21 (first holder), the second holder 22 (second holder), the image recording unit 30 (image recording portion), the laminating rollers 50 (laminating portion), the first conveying rollers 41 (first conveying roller), the rotary drive unit 71 (first rotary drive portion) for applying a first force to the first roll 111 via the first holder 21 to rotate the first roll 111, the conveying motor 81 (second rotary drive portion) for applying a second force to the first conveying rollers 41 to rotate the first conveying rollers 41, and the control unit 90. When the control unit 90 performs a control to drive the conveying motor 81 and apply the second force to the first conveying rollers 41 for conveying the first member 101 in a direction (draw-out direction) for drawing out the first member 101 from the first roll 111, the rotary drive unit 71 applies, via the first holder 21, the first force to the first roll 111 acting in a direction (take-up direction) for taking up the first member 101 onto the first roll 111.

Hence, with the laminating apparatus 1 according to the present embodiment, the second force acting in the direction for taking up the first member 101 is applied to the first roll 111 via the first holder 21 while the first member 101 is conveyed in the direction for drawing out the first member 101, thereby reducing the generation of slack in the portion (first drawn-out portion) of the first member 101 drawn out from the first roll 111. As a result, the finished laminated product 100 can be beautifully generated by laminating together the portion of the first member 101 on which an image has been recorded and which is free of slack, and the portion of the second member 102 drawn out from the second roll 112.

The first roll 111 and the second roll 112 have significant inertia. Therefore, when the control unit 90 stops drawing out the first member 101 from the first roll 111, the first roll 111 continues to rotate for a moment. As a result, an excessive amount of the first member 101 is drawn out from the first roll 111, generating slack in the portion of the first member 101 drawn out from the first roll 111. In its slackened state, the first member 101 may come into contact with or become entangled with components in the laminating apparatus 1, which can cause the first member 101 to become jammed.

Tension in the first member 101 affects conveyance accuracy of the first member 101. Since tension in the first member 101 changes when the first member 101 becomes slack, conveyance accuracy of the first member 101 may be reduced. Furthermore, a strong force is required to start rotating the first roll 111 from a halted state, whereas a weak force is required after rotation has begun. Slack in the first member 101 alternately generates a state in which a strong force is required and a state in which a weak force is sufficient. This instability in the required force reduces the conveyance accuracy of the first member 101. When the first member 101 has no slack so that tension can be maintained in the first member 101, the difference in the required force between when starting to rotate the first roll 11 and after rotation has begun is small, thereby improving the conveyance accuracy of the first member 101. Similarly, when control unit 90 starts rotating the second roll 112 mounted on the second holder 22 from a halted state, slack is generated in the first member 101 since the second roll 112 remains halted for a moment. Such slack can also reduce the conveyance accuracy of the first member 101. By reducing the generation of slack in the first member 101, the laminating apparatus 1 according to the present embodiment can prevent the first member 101 from becoming jammed and can prevent reductions in conveyance accuracy of the first member 101.

Since the output power from the first roll motor 72 (motor) limited by the torque limiter 73 (torque limiter) is transmitted to the first roll 111 via the first holder 21 as the first force, the torque limiter 73 can limit the first force applied to the first roll 111 via the first holder 21.

The control unit 90 performs a skew correction control to correct skew in the first member 101 (S11) in a state where the portion of the first member 101 drawn out from and connected to the first roll 111 is nipped between the first conveying rollers 41. In S11 the control unit 90 drives the conveying motor 81, applying a second force stronger than the first force to the first conveying rollers 41 to convey the first member 101 in the direction for drawing out the first member 101. Additionally, the control unit 90 conveys the first member 101 in the direction for taking up the first member 101 by (i) applying to the first conveying rollers 41 the second force in the direction for taking up the first member 101 while applying the first force in the direction for taking up the first member 101, (ii) refraining from applying the second force to the first conveying rollers 41 while applying the first force in the direction for taking up the first member 101, or (iii) applying to the first conveying rollers 41 the second force in the direction for drawing out the first member 101, the magnitude of the second force being smaller than the magnitude of the first force, while applying the first force in the direction for taking up the first member 101. The control unit 90 performs the skew correction control after the first roll 111 is mounted on the first holder 21 and before the first member 101 is nipped between the laminating rollers 50. The control unit 90 performs the skew correction control while the first member 101 is not nipped between the second conveying rollers 42. By performing the skew correction control on the first member 101 in this manner, the control unit 90 can provide the first member 101 to the laminating rollers 50 in a correct orientation to generate a beautiful finished laminated product 100.

The control unit 90 performs a first conveyance control (S12) while the first member 101 is not nipped between the second conveying rollers 42. In S12 the control unit 90 drives the conveying motor 81 to rotate the first conveying rollers 41 for conveying the first member 101 toward the second conveying rollers 42. At this time, the rotary drive unit 71 is applying the first force to the first roll 111. This method can prevent the generation of slack in the first member 101 when the first member 101 is conveyed toward the second conveying rollers 42.

The control unit 90 performs a slack elimination control (S13) after the first member 101 has been nipped between the second conveying rollers 42. In S13 the control unit 90 halts the second conveying rollers 42 and drives the conveying motor 81 to rotate the first conveying rollers 41 for conveying the portion of the first member 101 that is positioned between the first conveying rollers 41 and the second conveying rollers 42 in a direction away from the second conveying rollers 42, i.e., in the direction for taking up the first member 101, thereby reducing slack in the portion of the first member 101 that is positioned between the first conveying rollers 41 and the second conveying rollers 42. This method can reduce slack in the portion of the first member 101 between the first conveying rollers 41 and the second conveying rollers 42.

The control unit 90 performs a slack elimination control in S13 when the amount of slack detected by the slack sensor 63 (slack sensor) is greater than or equal to a predetermined amount. Accordingly, the control unit 90 performs the slack elimination control on the first member 101 positioned between the first conveying rollers 41 and the second conveying rollers 42 on the basis of the slack detected by the slack sensor 63 only when necessary.

The rotary drive unit 71 also applies the first force to the first roll 111 via the first holder 21 when the control unit 90 is performing the slack elimination control. Accordingly, the control unit 90 can reduce slack in the portion of the first member 101 positioned between the first roll 111 and the first conveying rollers 41 and slack in the portion of the first member 101 positioned between the first conveying rollers 41 and the second conveying rollers 42. The tension generating unit 60 (tension generating portion) can also reduce slack in the portion of the first member 101 positioned between the first conveying rollers 41 and the second conveying rollers 42.

The control unit 90 performs a second conveyance control in S14 for controlling both the first conveying rollers 41 and the second conveying rollers 42 to convey the first member 101 simultaneously. This process can reduce the generation of slack during conveyance. In the second conveyance control, the control unit 90 controls the speed at which the second conveying rollers 42 convey the first member 101 to be slower than the speed at which the first conveying rollers 41 convey the first member 101. When the control unit 90 continues this second conveyance control in which the conveying speed of the second conveying rollers 42 is slower than the conveying speed of the first conveying rollers 41, slack in the first member 101 will increase by an amount corresponding to the difference in conveying speeds of the two pairs of conveying rollers, thereby simplifying the estimation of the amount of slack.

In S14 control unit 90 performs the second conveyance control to convey the first member 101 to the image recording unit 30. In S15 the control unit 90 discontinues the second conveyance control and drives the image recording unit 30 to record an image on the first member 101 while the first member 101 is in a halted state. By conveying the first member 101 intermittently and recording an image on the first member 101 while the first member 101 is halted in this way, the control unit 90 can record images on the first member 101 accurately.

In S16 the control unit 90 determines whether the first member 101 has reached the laminating rollers 50 based on whether the member sensor 64 (member sensor) has detected the first member 101. Hence, the control unit 90 can begin lamination after determining that the first member 101 has reached the laminating rollers 50 based on the detection results of the member sensor 64.

In S14 the control unit 90 determines the conveyance amount of the first member 101 based on the rotated amount detected by the rotary encoder 83 (rotation sensor) when conveying the first member 101 toward the laminating rollers 50. Therefore, the control unit 90 can convey the first member 101 to the laminating rollers 50 by determining the conveyance amount of the first member 101 based on the rotated amount of the second conveying rollers 42 detected by the rotary encoder 83.

In S12 the control unit 90 determines the conveyance amount of the first member 101 based on the rotated amount detected by the rotary encoder 82 (rotation sensor) when conveying the first member 101 toward the second conveying rollers 42. Therefore, the control unit 90 can covey the first member 101 to the second conveying rollers 42 by determining the conveyance amount of the first member 101 based on the rotated amount of the first conveying rollers 41 detected by the rotary encoder 82.

The rotary drive unit 77 (third rotary drive portion) applies the power of the lamination motor 78 (motor) limited by the torque limiter 79 (torque limiter) to the laminating rollers 50 as the third force. Accordingly, the torque limiter 79 can limit the third force being applied to the laminating rollers 50.

Once the first member 101 has reached the laminating rollers 50, the control unit 90 alternately performs a conveyance control (S14) for conveying the first member 101 and a stopping control (S15) for halting conveyance of the first member 101. The control unit 90 drives the image recording unit 30 to record an image on the first member 101 during the stopping control; drives the rotary drive unit 77 to apply the third force to the laminating rollers 50 while the first member 101 is being conveyed by the second conveying rollers 42 during the conveyance control; and drives the rotary drive unit 77 to apply the third force to the laminating rollers 50 while the second conveying rollers 42 are in a halted state during the stopping control. Thus, the control unit 90 conveys the first member 101 intermittently and records an image on the first member 101 in the halted state while constantly applying the third force to the laminating rollers 50 to reduce the generation of slack in the first member 101. Furthermore, since a force is constantly applied to the second conveying rollers 42, the control unit 90 can ensure that the conveyance amount of the first member 101 is stable, thereby reducing distortion in the recorded image.

When the first member 101 connected to the first roll 111 and the second member 102 connected to the second roll 112 are nipped between the laminating rollers 50, the control unit 90 halts the driving of the rotary drive unit 77 before driving the first cutting unit 68 to cut the first member 101 (S20, S21). If the first member 101 were cut with the rotary drive unit 77 still in operation, the cutting line could shift from the force being applied to the first member 101. Moreover, the first member 101 could become skewed. By halting the operation of the rotary drive unit 77 and cutting the first member 101 in a halted state, skewing of the first member 101 can be prevented, and the first member 101 can be cut cleanly.

After halting the driving of the rotary drive unit 74, the control unit 90 also drives the second cutting unit 69 to cut the first member 101 and second member 102 laminated by the laminating rollers 50 (S22, S23). By halting the operation of the rotary drive unit 74 to cut the laminated first member 101 and second member 102 in a halted state in this way, the control unit 90 can cleanly cut the laminated first member 101 and second member 102.

After completing the cutting operation of S23, the control unit 90 performs a rewinding control (S24). In S24 the control unit 90 drives the rotary drive units 71 and 74 to rotate the first conveying rollers 41 and the second conveying rollers 42 in the reverse direction for conveying the first member 101 toward the first roll 111. Rewinding the first member 101 after a cut in this way can prevent wasteful use of the first member 101.

In S24 the control unit 90 drives the rotary drive units 71 and 74 to convey the first member 101 until the leading edge of the first member 101 is positioned between the first conveying rollers 41 and the second conveying rollers 42. In this way, rewinding the first member 101 after the first member 101 has been cut can prevent marks from appearing in the first member 101 due to the same portion of the first member 101 being nipped by the second conveying rollers 42 for a long period of time.

Once the leading edge of the first member 101 is positioned between the first conveying rollers 41 and the second conveying rollers 42, the control unit 90 drives the maintenance unit 86 to clean the recording head 32 (see FIG. 10). By positioning the leading edge of the first member 101 between the first conveying rollers 41 and the second conveying rollers 42, the control unit 90 can clean the recording head 32 without interference from the first member 101. Moreover, the recording head 32 can be cleaned while the first member 101 is nipped between the first conveying rollers 41, even when the driving of the maintenance unit 86 is interlocked with the rotation of the second conveying rollers 42.

### Variations of the Embodiment

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

The laminating apparatus 1 according to the above embodiment can be configured with numerous variations. A laminating apparatus according to one variation includes at least the first holder 21, the second holder 22, the image recording unit 30, the laminating rollers 50, the first conveying rollers 41, a first rotary drive unit that applies, via the first holder 21, a first force to the first roll 111 for rotating the first roll 111, a second rotary drive unit that applies a second force to the first conveying rollers 41 for rotating the first conveying rollers 41, and the control unit 90 (see FIG. 11). In the laminating apparatus according to this variation, when the control unit 90 drives the second rotary drive unit to apply a force to the first conveying rollers 41 for conveying the first member 101 in the direction for drawing out the first member 101 from the first roll 111, the first rotary drive unit continues to apply, via the first holder 21, a force to the first roll 111 acting in the direction for taking up the first member 101. The laminating apparatus according to this variation can reduce the generation of slack in the first member 101 in a manner similar to the laminating apparatus 1 of the embodiment.

The laminating apparatus according to a variation does not necessarily include the third conveying rollers 43 and the fourth conveying rollers 44. Thus, the second conveying rollers 42 may be disposed in the position of the third conveying rollers 43 or the fourth conveying rollers 44 in this variation.

In S13 of the laminating process, the control unit 90 in the laminating apparatus of a variation may rotate the second conveying rollers 42 in the forward direction rather than rotating the first conveying rollers 41 in the reverse direction. Specifically, in S13 the control unit 90 may perform a slack elimination control for reducing slack in the portion of the first member 101 positioned between the first conveying rollers 41 and the second conveying rollers 42 by halting the first conveying rollers 41 and driving the conveying motor 81 to rotate the second conveying rollers 42 in the direction for conveying the portion of the first member 101 positioned between the first conveying rollers 41 and second conveying rollers 42 away from the first conveying rollers 41, i.e., in the direction for taking up the first member 101. Through this slack elimination control, the control unit 90 can reduce the generation of slack in the portion of the first member 101 positioned between the first conveying rollers 41 and the second conveying rollers 42.

The control unit of the laminating apparatus according to a variation may perform a slack generation control to generate slack in the first member 101 when the amount of slack detected by the slack sensor 63 is less than or equal to a predetermined amount. This predetermined amount is an example of the predetermined amount of the present disclosure. In this variation, the control unit halts the second conveying rollers 42 after the first member 101 has become nipped between the second conveying rollers 42 and generates slack in the portion of the first member 101 positioned between the first conveying rollers 41 and the second conveying rollers 42 by either rotating the first conveying rollers 41 forward or halting the first conveying rollers 41 and rotating the second conveying rollers 42 in reverse. This method enables the control unit 90 to maintain the amount of slack in the portion of the first member 101 positioned between the first conveying rollers 41 and the second conveying rollers 42 at an appropriate level.

The control unit of the laminating apparatus according to a variation may control the speed at which the second conveying rollers 42 convey the first member 101 to be faster than the speed at which the first conveying rollers 41 convey the first member 101. In this case, slack in the portion of the first member 101 positioned between the first conveying rollers 41 and the second conveying rollers 42 decreases over time. When the control unit 90 determines that the amount of slack in the first member 101 is greater than or equal to a predetermined amount on the basis of the output signal from the slack sensor 63, the control unit 90 rotates the first conveying rollers 41 faster than normal. This configuration can also adjust the amount of slack in the portion of the first member 101 positioned between the first conveying rollers 41 and the second conveying rollers 42 to a predetermined amount. In a second conveyance control, the control unit of this laminating apparatus may either control the speed at which the first conveying rollers 41 convey the first member 101 to be faster than the speed at which the second conveying rollers 42 convey the first member 101 or control the speed at which the second conveying rollers 42 convey the first member 101 to be faster than the speed at which the first conveying rollers 41 convey the first member 101.

The laminating apparatus according to a variation may include a stepping motor as the conveying motor 81. In this case, the control unit may detect the rotated amount of the first conveying rollers 41 and the rotated amount of the second conveying rollers 42 on the basis of the output signal from the stepping motor.

Instead of the member sensor 64, the laminating apparatus of a variation may include a sensor mounted on the carriage 31 that moves in the left-right direction together with the carriage 31 (hereinafter referred to as the “media sensor”). As with the member sensor 64, the media sensor may be an optical sensor that includes a light-emitting element and a light-receiving element, for example.

The laminating apparatus according to a variation may include a laminating unit that contains a single laminating roller. By arranging this single laminating roller at a suitable location inside the housing 11, the single laminating roller can be used to laminate a portion of the first member 101 drawn out from the first roll 111 and a portion of the second member 102 drawn out from the second roll 112 together after the image recording unit 30 has recorded an image on the portion of the first member 101. Alternatively, the laminating unit in the laminating apparatus of a variation need not include a rotating roller. For example, the laminating unit may include two plate-shaped members spaced apart from each other in the up-down direction. In this case, the laminating unit may include a holding member positioned downstream relative to the plate-shaped members in the conveying direction for holding the first member 101 and the second member 102 and pulling the first member 101 and the second member 102 in a predetermined direction.

The laminating apparatus according to a variation need not include the second cutting unit 69. In this case, the laminated member generated by laminating the first member 101 and the second member 102 together is discharged through the discharge opening 14 without being cut. The user then manually cuts the laminated member discharged outside the laminating apparatus with scissors, for example.

The image recording unit 30 of the laminating apparatus 1 according to the above embodiment includes the recording head 32 that ejects ink and records images according to the serial inkjet method, but the image recording unit 30 is not limited to this configuration. For example, the image recording unit of the laminating apparatus in a variation may include a fixed inkjet recording head that records images according to the line head method. Alternatively, the recording head in the laminating apparatus according to a variation may be configured to record images using the thermal head method. Alternatively, the recording head in the laminating apparatus according to a variation may record images according to the laser method in which toner is fixed to a recording medium using a laser beam.

What is claimed is:

1. A laminating apparatus comprising:
a first holder on which a first roll is mountable, the first roll being a first member that is wound into a roll;
a second holder on which a second roll is mountable, the second roll being a second member that is wound into a roll;
an image recording portion;
a laminating portion;
a first conveying roller disposed at a position between the first holder and the laminating portion, the first conveying roller being configured to hold a first drawn-out portion of the first member, the first drawn-out portion being a portion of the first member that has been drawn out from the first roll;
a first rotary drive portion;
a second rotary drive portion; and
a controller configured to perform:
recording, using the image recording portion, an image on the first drawn-out portion;
laminating, using the laminating portion, the first drawn-out portion on which the image is recorded and a second drawn-out portion of the second member together, the second drawn-out portion being a portion of the second member that has been drawn out from the second roll;
applying, using the first rotary drive portion, a first force to the first holder, the first force urging the first holder to rotate together with the first roll mounted on the first holder; and
applying, using the second rotary drive portion, a second force to the first conveying roller, the second force rotating the first conveying roller,
wherein, when driving, in a state where the first conveying roller holds the first drawn-out portion, the second rotary drive portion to apply the second force to rotate the first conveying roller for conveying the first drawn-out portion in a draw-out direction, the controller drives the first rotary drive portion to apply the first force to act on the first holder for urging the first drawn-out portion to be conveyed in a take-up direction opposite the draw-out direction.

2. The laminating apparatus according to claim 1,
wherein the first rotary drive portion comprises:
a motor; and
a torque limiter interposed between the motor and the first holder, the torque limiter being configured to limit a power of the motor to transmit the limited power to the first holder as the first force.

3. The laminating apparatus according to claim 1,
wherein the controller is configured to further perform:
a skew correction control in a state where the first conveying roller holds the first drawn-out portion, the skew correction control including:
conveying the first drawn-out portion in the draw-out direction by driving the second rotary drive portion to apply the second force for conveying the first drawn-out portion in the draw-out direction while driving the first rotary drive portion to apply the first force for urging the first drawn-out portion to be conveyed in the take-up direction, the second force having a magnitude greater than a magnitude of the first force; and
conveying the first drawn-out portion in the take-up direction by one of:
driving the second rotary drive portion to apply the second force for conveying the first drawn-out portion in the draw-out direction while driving the first rotary drive portion to apply the first force for urging the first drawn-out portion to be conveyed in the take-up direction, the second force having a magnitude smaller than the magnitude of the first force;
refraining from applying the second force to the first conveying roller while driving the first rotary drive portion to apply the first force for urging the first drawn-out portion to be conveyed in the take-up direction; and
driving the second rotary drive portion to apply the second force for conveying the first drawn-out portion in the take-up direction while driving the first rotary drive portion to apply the first force for urging the first drawn-out portion to be conveyed in the take-up direction.

4. The laminating apparatus according to claim 3,
wherein the controller performs the skew correction control after the first roll has been mounted on the first holder and before the laminating portion holds the first drawn-out portion.

5. The laminating apparatus according to claim 3, further comprising:
a second conveying roller disposed at a position between the first conveying roller and the laminating portion, the second conveying roller being configured to hold the first drawn-out portion,
wherein the controller performs the skew correction control in a state where the second conveying roller does not hold the first drawn-out portion.

6. The laminating apparatus according to claim 1, further comprising:
a second conveying roller disposed at a position between the first conveying roller and the laminating portion, the second conveying roller being configured to hold the first drawn-out portion,
wherein the controller is configured to further perform:
a first conveyance control in a state where the second conveying roller does not hold the first drawn-out portion, the first conveyance control including:
conveying the first drawn-out portion in the draw-out direction toward the second conveying roller by driving the second rotary drive portion to apply the second force for conveying the first drawn-out portion in the draw-out direction, and
wherein the first force is applied to the first holder while the first conveyance control is performed.

7. The laminating apparatus according to claim 6,
wherein the controller is configured to further perform:
a slack elimination control in a state where the second conveying roller holds the first drawn-out portion, the slack elimination control including:
driving the second rotary drive portion to apply the second force for conveying the first drawn-out portion in the take-up direction while maintaining the second conveying roller in a halted state.

8. The laminating apparatus according to claim 6,
wherein the controller is configured to further perform:
a slack elimination control in a state where the second conveying roller holds the first drawn-out portion, the slack elimination control including:
halting the second rotary drive portion to place the first conveying roller in a halted state; and
rotating the second conveying roller to cause the first drawn-out portion to be conveyed in the take-up direction.

9. The laminating apparatus according to claim 8, further comprising:
a slack sensor configured to detect an amount of a slack in a portion of the first drawn-out portion that is positioned between the first conveying roller and the second conveying roller,
wherein the controller performs the slack elimination control in response to the slack sensor detecting the amount of the slack greater than or equal to a predetermined amount.

10. The laminating apparatus according to claim 7, further comprising:
a slack sensor configured to detect an amount of a slack in a portion of the first drawn-out portion that is positioned between the first conveying roller and the second conveying roller,
wherein the controller is configured to further perform:
a slack generation control including:
generating a slack in the portion of the first drawn-out portion in response to the slack sensor detecting the amount of the slack smaller than a predetermined amount.

11. The laminating apparatus according to claim 8,
wherein the first force is applied to the first holder while the slack elimination control is performed.

12. The laminating apparatus according to claim 6, further comprising:
a tension generating portion,
wherein the controller is configured to further perform:
generating, using the tension generating portion, a predetermined tension in a portion of the first drawn-out portion that is positioned between the first conveying roller and the second conveying roller.

13. The laminating apparatus according to claim 6,
wherein the controller is configured to further perform:
a second conveyance control including:
conveying the first drawn-out portion in the draw-out direction using both the first conveying roller and the second conveying roller by driving the second rotary drive portion to rotate the first conveying roller and rotating the second conveying roller simultaneously.

14. The laminating apparatus according to claim 13,
wherein, in the second conveyance control, the controller performs one of:
a first speed control including:
controlling a conveyance speed at which the second conveying roller conveys the first drawn-out portion to be slower than a conveyance speed at which the first conveying roller conveys the first drawn-out portion; and
a second speed control including:
controlling the conveyance speed at which the second conveying roller conveys the first drawn-out portion to be faster than the conveyance speed at which the first conveying roller conveys the first drawn-out portion.

15. The laminating apparatus according to claim 13,
wherein the controller performs the second conveyance control to convey the first drawn-out portion until the first drawn-out portion reaches the image recording portion, and driving the image recording portion to record an image on the first drawn-out portion while maintaining the first drawn-out portion in a halted state without performing the second conveyance control.

16. The laminating apparatus according to claim 6, further comprising:
a member sensor disposed at a position between the second conveying roller and the laminating portion, the member sensor being configured to detect the first drawn-out portion,
wherein the controller is configured to determine, in response to the member sensor detecting the first drawn-out portion, that the first drawn-out portion has reached the laminating portion.

17. The laminating apparatus according to claim 6, further comprising:
a rotation sensor configured to detect a rotated amount of the second conveying roller,
wherein the controller is configured to determine a conveyance amount of the first drawn-out portion based on the rotated amount detected by the rotation sensor when conveying the first drawn-out portion toward the laminating portion.

18. The laminating apparatus according to claim 6, further comprising:
a rotation sensor configured to detect a rotated amount of the first conveying roller,
wherein the controller is configured to determine a conveyance amount of the first drawn-out portion based on the rotated amount detected by the rotation sensor when conveying the first drawn-out portion toward the second conveying roller.

19. The laminating apparatus according to claim 6, further comprising:
a third rotary drive portion,
wherein the laminating portion comprises:
a laminating roller,
wherein the laminating includes:
applying, using the third rotary drive portion, a third force to the laminating roller, the third force rotating the laminating roller to laminate the first drawn-out portion on which the image is recorded and the second drawn-out portion together, and
wherein the third rotary drive portion comprises:
a motor; and
a torque limiter interposed between the motor and the laminating roller, the torque limiter being configured to limit a power of the motor to transmit the limited power to the laminating roller as the third force.

20. The laminating apparatus according to claim 19,
wherein the controller is configured to alternately perform, after the first drawn-out portion reaches the laminating roller:
a conveyance control including:
conveying the first drawn-out portion; and
a stopping control including:
halting conveyance of the first drawn-out portion,
wherein the controller drives the image recording portion to record an image on the first drawn-out portion during performing the stopping control,
wherein the controller drives the third rotary drive portion to apply the third force to the laminating roller while performing the conveyance control by rotating the second conveying roller, and
wherein the controller drives the third rotary drive portion to apply the third force to the laminating roller while maintaining the second conveying roller in a halted state during performing the stopping control.

21. The laminating apparatus according to claim 20, further comprising:
a cutter disposed at a position between the second conveying roller and the laminating roller,
wherein the controller is configured to further perform:
cutting, using the cutter, the first drawn-out portion into a roll-connected portion connected to the first roll and a cut-off portion cut off from the roll-connected portion, and
wherein the controller drives the cutter to cut the first drawn-out portion after halting the third rotary drive portion in a state where the laminating roller holds the first drawn-out portion connected to the first roll and the second drawn-out portion connected to the second roll.

22. The laminating apparatus according to claim 1, further comprising:
a cutter disposed downstream relative to the laminating portion in the draw-out direction,
wherein the controller is configured to further perform:
cutting, using the cutter, the first drawn-out portion and the second drawn-out portion that have been laminated together by performing the laminating, and
wherein the controller drives the cutter to cut a laminated portion including the first drawn-out portion and the second drawn-out portion after halting the second rotary drive portion.

23. The laminating apparatus according to claim 21,
wherein the controller is configured to further perform:
a rewinding control after driving the cutter to cut the first drawn-out portion, the rewinding control including:
conveying the roll-connected portion in the take-up direction toward the first holder by driving, while driving the first rotary drive portion to apply the first force for urging the first drawn-out portion to be conveyed in the take-up direction, the second rotary drive portion to apply the second force for conveying the roll-connected portion in the take-up direction.

24. The laminating apparatus according to claim 23,
wherein, in the rewinding control, the controller drives the first rotary drive portion and the second rotary drive portion such that a leading edge of the roll-connected portion in the draw-out direction is positioned between the first conveying roller and the second conveying roller.

25. The laminating apparatus according to claim 24, further comprising:
a maintenance portion,
wherein the image recording portion comprises:
a head,
wherein the controller is configured to further perform:
cleaning, using the maintenance portion, the head, and
wherein the controller drives the maintenance portion to clean the head in a state where the leading edge of the roll-connected portion is positioned between the first conveying roller and the second conveying roller.
